(19) United States
(12) Patent Application Publication
(10) Pub. No.: US 2013/0314050 A1
(43) Pub. Date: Nov. 28, 2013

(54) CHARGE CONTROL DEVICE FOR SECONDARY BATTERY, CHARGE CONTROL METHOD FOR SECONDARY BATTERY, CHARGE STATE ESTIMATION DEVICE FOR SECONDARY BATTERY, CHARGE STATE ESTIMATION METHOD FOR SECONDARY BATTERY, DEGRADATION DEGREE ESTIMATION DEVICE FOR SECONDARY BATTERY, DEGRADATION DEGREE ESTIMATION METHOD FOR SECONDARY BATTERY, AND SECONDARY BATTERY DEVICE

(71) Applicant: Sony Corporation, Tokyo (JP)

(72) Inventors: Kenji Matsubara, Tokyo (JP); Shinichi Uesaka, Kanagawa (JP); Msatomo Tanaka, Kanagawa (JP)

(73) Assignee: Sony Corporation, Tokyo (JP)

(21) Appl. No.: 13/899,058

(22) Filed: May 21, 2013

(30) Foreign Application Priority Data
May 28, 2012 (JP) 2012-120454

(51) Int. Cl. H02J 7/00

(52) U.S. Cl. CPC H02J 7/00
USPC 320/134; 320/162

(57) ABSTRACT

A charge control device for a secondary battery controls a charge of the secondary battery including positive and negative electrodes. The device includes: a degradation degree detection and evaluation unit that detects and evaluates a degree of degradation of the secondary battery; and a charge control unit. The charge control unit controls a voltage application state to the electrode at a time of charge of the secondary battery based on an evaluation result of the degree of degradation of the second battery in the degradation degree detection and evaluation unit.

### BACKGROUND

The present disclosure relates to a charge control device for a secondary battery, a charge control method for the secondary battery, a charge state estimation device for a secondary battery, a charge state estimation method for a secondary battery, a degradation degree estimation device for a secondary battery, a degradation degree estimation method for a secondary battery, and a secondary battery device.

In a charge of a secondary battery such as a lithium-ion secondary battery, generally, constant-current charge is first performed and constant-voltage charge is subsequently performed to fully charge the secondary battery. Such a charge method is called a constant-current and constant-voltage charge method (CC-CV method). Here, the constant-current charge is performed until a voltage (also referred to as a “cell voltage”) between the positive and negative electrodes of a secondary battery increases up to a set voltage. When the cell voltage increases up to the set voltage, the constant-current charge is switched to the constant-voltage charge so that the cell voltage does not increase considerably. In the constant-voltage charge, a charge current of the secondary battery gradually decreases. When the charge current is less than a set value, the secondary battery is determined to be fully charged and the charge ends. A full-charge voltage which is a cell voltage at the time of the constant-voltage charge is set to, for example, 4.1 volt/cell to 4.2 volt/cell.

When the charge and discharge of a secondary battery is repeated, degradation occurs in the capacity of the secondary battery. In order to resolve this problem, for example, Japanese Unexamined Patent Application Publication No. 2008-005644 discloses a battery charge method of fully charging a battery by setting a set voltage at which the battery is charged to be low as the battery is repeatedly charged and discharged. In regard to a non-aqueous secondary battery, Japanese Unexamined Patent Application Publication No. 2000-300750 discloses a charge method of stopping a charge before a closed circuit voltage of the non-aqueous secondary battery reaches a decomposition voltage of a non-aqueous electrolyte after start of the charge. Japanese Unexamined Patent Application Publication No. 2001-307781 discloses a lithium secondary battery that includes a charge/discharge control device including a discharge control unit configured to set and control a discharge termination voltage to be in the range of 3.2 volts to 2.1 volts at the time of discharge and a charge control unit configured to set and control a charge upper limit voltage to be in the range of 4.0 volts to 4.5 volts at the time of charge.

The amount of remaining capacity of a secondary battery is frequently evaluated as a state of charge (SOC) [%] on the assumption that a full-charge capacity (maximum charge capacity; full charge capacity) is 100%. An open circuit voltage (OCV) is frequently used as an index of SOC diagnosis after discharge. Specifically, Japanese Unexamined Patent Application Publication No. 2000-258513 discloses a charge state estimation technology for estimating an SOC based on an OCV from a relation between the initial OCV and SOC. Further, as a charge state estimation technology for considering degradation of a secondary battery, Japanese Unexamined Patent Application Publication No. 2002-286818 discloses a technology for estimating an SOC by selecting an OCV-SOC relation prepared in advance according to the degree of degradation of a battery.

### SUMMARY

The inventors and others have examined and proved that a phenomenon in which a potential of a negative electrode increases with capacity degradation of a secondary battery occurs. It is considered that this is because lithium (Li) is precipitated irreversibly due to repetition of charge and discharge of a lithium-ion secondary battery and an amount of lithium contributing the charge and discharge consequently decreases. In general, since a secondary battery is charged by causing a full-charge voltage of the secondary battery to be constant, a potential increase of a negative electrode causes a potential increase of a positive electrode. When the potential increase of the positive electrode is caused, a side reaction (oxidation of electrolyte, structure degradation of a positive-electrode active material, or the like) occurs in the positive electrode. As a consequence, there is a concern that capacity degradation of the secondary battery may accelerate. In Japanese Unexamined Patent Application Publication No. 2008-005644, Japanese Unexamined Patent Application Publication No. 2000-300750, and Japanese Unexamined Patent Application Publication No. 2001-307781, a technology for quantitatively determining the degree of degradation (specifically, for example, an increase in the potential of the negative electrode) of a secondary battery under an actual use environment and setting a subsequent charge voltage is not mentioned. Likewise, in Japanese Unexamined Patent Application Publication No. 2000-258513 and Japanese Unexamined Patent Application Publication No. 2002-286818, a technology for quantitatively determining the degree of degradation (specifically, for example, an increase in the potential of the negative electrode) of a secondary battery under an actual use environment and improving estimation accuracy of an SOC based on an OCV is not mentioned. Further, in Japanese Unexamined Patent Application Publication No. 2008-005644, Japanese Unexamined Patent Application Publication No. 2000-300750, Japanese Unexamined Patent Application Publication No. 2001-307781, Japanese Unexamined Patent Application Publication No. 2000-258513, and Japanese Unexamined Patent Application Publication No. 2002-286818, a technology for efficiently estimating the degree of degradation of a secondary battery is not mentioned.

It is desirable to provide a charge control device for a secondary battery, a secondary battery device including the charge control device, and a charge control method for the secondary battery capable of quantitatively determining the degree of degradation of the secondary battery under an actual use environment and setting a subsequent charge voltage. It is desirable to also provide a charge state estimation device for a secondary battery, a secondary battery device including the charge state estimation device, and a charge state estimation method for the secondary battery capable of quantitatively determining the degree of degradation of the secondary battery under an actual use environment and improving estimation accuracy of an SOC based on an OCV. It is desirable to also provide a degradation degree estimation device, a secondary battery device including the degradation degree estimation device, and a degradation degree estimation method for a secondary battery capable of efficiently estimating the degree of degradation of a secondary battery under an actual use environment.

According to an embodiment of the present disclosure, there is provided a charge control device for a secondary battery that controls a charge of the secondary battery including positive and negative electrodes. The device includes: a degradation degree detection and evaluation unit that detects and evaluates a degree of degradation of the secondary battery; and a charge control unit. The charge control unit controls a voltage application state to the electrode at a time of charge of the secondary battery based on an evaluation result of the degree of degradation of the second battery in the degradation degree detection and evaluation unit.

According to another embodiment of the present disclosure, there is provided a secondary battery device including: a secondary battery that includes positive and negative electrodes; and a charge control device that controls a charge of the secondary battery. The charge control device includes a degradation degree detection and evaluation unit that detects and evaluates a degree of degradation of the secondary battery, and a charge control unit. The charge control unit controls a voltage application state to the electrode at a time of charge of the secondary battery based on an evaluation result of the degree of degradation of the second battery in the degradation degree detection and evaluation unit.

According to still another embodiment of the present disclosure, there is provided a charge control method for a secondary battery. The charge control method of controlling charge of the secondary battery including positive and negative electrodes includes: detecting and evaluating a degree of degradation of the secondary battery; and controlling a voltage application state to the electrode at a time of full charge of the secondary battery based on an evaluation result of the degree of degradation of the secondary battery.

According to still another embodiment of the present disclosure, there is provided a charge state estimation device for a secondary battery including positive and negative electrodes. The charge state estimation device includes: a degradation degree detection and evaluation unit that detects and evaluates a degree of degradation of the secondary battery; and a correction unit that corrects a relation between a state of charge and an open circuit voltage. The correction unit corrects the relation between the state of charge and the open circuit voltage based on an evaluation result of the degree of degradation of the second battery in the degradation degree detection and evaluation unit.

According to still another embodiment of the present disclosure, there is provided a secondary battery device including: a secondary battery that includes positive and negative electrodes; and a charge state estimation device for a secondary battery. The charge state estimation device includes a degradation degree detection and evaluation unit that detects and evaluates a degree of degradation of the secondary battery, and a correction unit that corrects a relation between a state of charge and an open circuit voltage. The correction unit corrects the relation between the state of charge and the open circuit voltage based on an evaluation result of the degree of degradation of the second battery in the degradation degree detection and evaluation unit.

According to still another embodiment of the present disclosure, there is provided a charge state estimation method for a secondary battery. The charge state estimation method of estimating a charge state of the secondary battery including positive and negative electrodes includes: detecting and evaluating a degree of degradation of the secondary battery; and correcting a relation between a state of charge and an open circuit voltage based on an evaluation result of the degree of degradation of the secondary battery.

According to still another embodiment of the present disclosure, there is provided a degradation degree estimation device for a secondary battery including positive and negative electrodes. The degradation degree estimation device includes a degradation degree detection and evaluation unit that detects and evaluates a degree of degradation of the secondary battery. The degradation degree detection and evaluation unit measures a voltage change between the positive and negative electrodes at a time of charge or discharge of the secondary battery, calculates an inflection point in the measured voltage change and a voltage value at the inflection point, and calculates the degree of degradation of the secondary battery based on a difference between the inflection point and a precalculated initial inflection point and a difference between the voltage value at the inflection point and an initial voltage value at the precalculated initial inflection point.

According to still another embodiment of the present disclosure, there is provided a degradation degree estimation device for a secondary battery including positive and negative electrodes. The degradation degree estimation device includes a degradation degree detection and evaluation unit that detects and evaluates a degree of degradation of the secondary battery. The degradation degree detection and evaluation unit measures a voltage change between the positive and negative electrodes at a time of charge or discharge of the secondary battery, calculates an inflection point in the measured voltage change and a voltage value at the inflection point, and calculates the degree of degradation of the secondary battery based on a voltage value at the inflection point and stored charge/discharge history data of the secondary battery.

According to still another embodiment of the present disclosure, there is provided a secondary battery device including: a secondary battery that includes positive and negative electrodes; and a degradation degree estimation device for the secondary battery. The degradation degree estimation device includes a degradation degree detection and evaluation unit that detects and evaluates a degree of degradation of the secondary battery. The degradation degree detection and evaluation unit measures a voltage change between the positive and negative electrodes at a time of charge or discharge of the secondary battery, calculates an inflection point in the measured voltage change and a voltage value at the inflection point, and calculates the degree of degradation of the secondary battery based on a difference between the inflection point and a precalculated initial inflection point and a difference between the voltage value at the inflection point and an initial voltage value at the precalculated initial inflection point.

According to still another embodiment of the present disclosure, there is provided a secondary battery device including: a secondary battery that includes positive and negative electrodes; and a degradation degree estimation device for the secondary battery. The degradation degree estimation device includes a degradation degree detection and evaluation unit that detects and evaluates a degree of degradation of the secondary battery. The degradation degree detection and evaluation unit measures a voltage change between the positive and negative electrodes at a time of charge or discharge of the secondary battery, calculates an inflection point in the measured voltage change and a voltage value at the inflection point, and calculates the degree of degradation of the secondary battery based on a voltage value at the inflection point and stored charge/discharge history data of the secondary battery.

According to still another embodiment of the present disclosure, there is provided a degradation degree estimation method for a secondary battery. The degradation degree estimation method of estimating a charge state of the secondary battery including positive and negative electrodes includes: measuring a voltage change between the positive and negative electrodes at a time of charge or discharge of the secondary battery and calculating an inflection point in the measured voltage change and a voltage value at the inflection point; and calculating the degree of degradation of the secondary battery based on a difference between the inflection point and a precalculated initial inflection point and a difference between the voltage value at the inflection point and an initial voltage value at the precalculated initial inflection point.

According to still another embodiment of the present disclosure, there is provided a degradation degree estimation method for a secondary battery. The degradation degree estimation method of estimating a charge state of the secondary battery including positive and negative electrodes includes: measuring a voltage change between the positive and negative electrodes at a time of charge or discharge of the secondary battery and calculating an inflection point in the measured voltage change and a voltage value at the inflection point; and calculating the degree of degradation of the secondary battery based on a voltage value at the inflection point and charge/discharge history data of the secondary battery.

The charge control device for a secondary battery according to the embodiment of the present disclosure, the charge control method for the secondary battery according to the embodiment of the present disclosure, or the secondary battery device of a first form according to the embodiment of the present disclosure controls a voltage application state to an electrode at the time of charge of the secondary battery based on an evaluation result of the degree of degradation of the secondary battery. Therefore, since the degree of degradation of the secondary battery can be quantitatively determined under an actual use environment and a subsequent charge voltage can be set, the secondary battery can be charged under an optimum condition. Further, the charge state estimation device for a secondary battery according to the embodiment of the present disclosure, the charge state estimation method for the secondary battery according to the embodiment of the present disclosure, or the secondary battery device of a second form according to the embodiment of the present disclosure corrects the relation between the state of charge and the open circuit voltage based on the evaluation result of the degree of degradation of the secondary battery under an actual use environment. Therefore, since a deviation of balance between the positive and negative electrodes caused due to the degradation of the secondary battery can be corrected, it is possible to improve estimation accuracy of the state of charge based on the measurement result of the open circuit voltage. The degradation degree estimation devices of first and second forms for the secondary battery according to the embodiments of the present disclosure, the secondary battery device of third and fourth forms according to the embodiments of the present disclosure, and the degradation degree estimation method of first and second forms for the secondary battery according to the embodiments of the present disclosure may measure a voltage change between the positive and negative electrodes at the time of charge or discharge of the secondary battery and may calculate an inflection point in the measured voltage change and a voltage value at the inflection point. Therefore, the degree of degradation of the secondary battery can efficiently be estimated.

### BRIEF DESCRIPTION OF THE DRAWINGS

FIG. 1 is a block diagram illustrating a charge control device for a secondary battery and a secondary battery device according to a first embodiment;

FIG. 2A is a graph measuring how an open circuit voltage (OCV) varies at the time of discharge and an overlapping graph obtained by calculating (dV/dQ) from the obtained open circuit voltage curve;

FIG. 2B is a graph measuring how the potential of a positive electrode varies and an overlapping graph obtained by calculating (dV/dQ) from the obtained potential variation curve of the positive electrode;

FIG. 2C is a graph measuring how the potential of a negative electrode varies and an overlapping graph obtained by calculating (dV/dQ) from the obtained potential variation curve of the negative electrode;

FIG. 3 is a graph schematically illustrating how the potentials of the positive and negative electrodes at the time of discharge vary due to degradation of the secondary battery at the time of discharge and how the open circuit voltage (OCV) varies;

FIG. 4 is a graph schematically illustrating how the potential of the negative electrode varies due to the degradation of the secondary battery at the time of discharge in an expanded manner;

FIGS. 5A and 5B are a conceptual diagram illustrating an intermittent discharge and a diagram illustrating a relation between the intermittent discharge and the open circuit voltage (OCV), respectively;

FIGS. 6A and 6B are a graph measuring how the open circuit voltage (OCV) varies due to the degradation of the secondary battery at the time of discharge and a graph obtained by calculating (dV/dQ) from the obtained open circuit voltage curve, respectively;

FIG. 7 is a block diagram illustrating a charge state estimation device for a secondary battery and a secondary battery device according to a second embodiment;

FIG. 8 is a graph illustrating a correlation between the measured open circuit voltage (OCV) and a state of charge (SOC);

FIG. 9 is a block diagram illustrating a degradation degree estimation device for a secondary battery and a secondary battery device according to a third embodiment;

FIG. 10 is a diagram illustrating a difference between a voltage value at an inflection point and an initial voltage value at a precalculated initial inflection point and a difference between an inflection point and a precalculated initial inflection point according to the third embodiment;

FIG. 11 is a block diagram illustrating a degradation degree estimation device for a secondary battery and a secondary battery device according to a fourth embodiment; and

FIG. 12 is a diagram illustrating the configuration of a hybrid vehicle.

### DETAILED DESCRIPTION OF EMBODIMENTS

Hereinafter, embodiments of the present disclosure will be with reference to the drawings, but embodiments of the present disclosure are not limited thereto. Various numbers and materials in the embodiments are merely examples. The description will be made in the following order.

1. General Description of Charge Control Device for Secondary Battery, Charge Control Method for Secondary Battery, Charge State Estimation Devices for Secondary Battery, Charge State Estimation methods for Secondary Battery, Degradation Degree Estimation Device of First and Second Forms for Secondary Battery, Degradation Degree Estimation Method of First and Second Forms for Secondary Battery, and Secondary Battery Devices of First to Fourth Forms according to Embodiments of the Present Disclosure

2. First Embodiment (Charge Control Device for Secondary Battery, Charge Control Method for Secondary Battery, and Secondary Battery Device of First Form according to Embodiment of the Present Disclosure)

3. Second Embodiment (Charge State Estimation Device for Secondary Battery, Charge State Estimation Method for Secondary Battery, and Secondary Battery Device of Second Form according to Embodiment of the Present Disclosure)

4. Third Embodiment (Degradation Degree Estimation Device of First Form for Secondary Battery, Secondary Battery Device of Third Form, and Degradation Degree Estimation Method of First Form for Secondary Battery according to Embodiment of the Present Disclosure)

5. Fourth Embodiment (Degradation Degree Estimation Device of Second Form for Secondary Battery, Secondary Battery Device of Fourth Form, and Degradation Degree Estimation Method of Second Form for Secondary Battery according to Embodiment of the Present Disclosure) General Description of Charge Control Device for Secondary Battery, Charge Control Method for Secondary Battery, Charge State Estimation Devices for Secondary Battery, Charge State Estimation methods for Secondary Battery, Degradation Degree Estimation Device of First and Second Forms for Secondary Battery, Degradation Degree Estimation Method of First and Second Forms for Secondary Battery, and Secondary Battery Devices of First to Fourth Forms according to Embodiments of the Present Disclosure

In a charge control device for a secondary battery according to an embodiment of the present disclosure, a charge control device in a charge state estimation device for a secondary battery according to an embodiment of the present disclosure, a charge control device in a secondary battery device of a first form according to an embodiment of the present disclosure (hereinafter, the charge control devices are also collectively referred to as “charge control devices or the like according to the embodiments of the present disclosure”), a charge control unit may control a voltage application state to a positive electrode at a time of full charge of the secondary battery based on the evaluation result of the degree of degradation of the second battery in a degradation degree detection and evaluation unit. In a charge control method for a secondary battery according to an embodiment of the present disclosure, a voltage application state to a positive electrode at the time of charge of the secondary battery may be controlled based on an evaluation result of the degree of degradation of the second battery.

In the charge control devices or the like according to the preferred embodiment of the present disclosure, the charge control unit may set a potential of the positive electrode at the time of full charge of the secondary battery based on the evaluation result of the degree of degradation of the second battery in the degradation degree detection and evaluation unit. In the preferred configuration, the degradation degree detection and evaluation unit may measure a voltage change between the positive and negative electrodes at a time of charge or discharge of the secondary battery, calculate an inflection point in the measured voltage change, and calculate the degree of degradation of the secondary battery based on a difference between the inflection point and a precalculated initial inflection point. The charge control unit may set a potential of the positive electrode to be applied at the time of charge of the secondary battery based on the degree of degradation of the second battery calculated by the degradation degree detection and evaluation unit. In this case, the difference may be based on a relation between the inflection point in the measured voltage change and the precalculated initial inflection point. In this configuration, the inflection point in the measured voltage change may correspond to a peak (hereinafter, also referred to as a “differential value peak” for convenience) in differential values when the differential values of a voltage measured by setting a charge/discharge capacity of the secondary battery or a measurement time as a variable are calculated. A difference between values of variables such as charge/discharge capacities or measurement times obtained from the differential value peaks corresponds to the difference between the inflection point in the measured voltage change and the precalculated initial inflection point. The same also applies below.

In a charge control method for the secondary battery according to the preferred embodiment of the present disclosure described above, a potential of the positive electrode at a time of full charge of the secondary battery may be set based on the evaluation result of the degree of degradation of the second battery. In the preferred configuration, a voltage change between the positive and negative electrodes may be measured at a time of charge or discharge of the secondary battery, an inflection point in the measured voltage change may be calculated, and the degree of degradation of the secondary battery may be calculated based on a difference between the inflection point and a precalculated initial inflection point. A potential of the positive electrode to be applied at the time of full charge of the secondary battery may be set based on the degree of degradation of the second battery. In this case, the difference may be based on a relation between the inflection point in the measured voltage change and the precalculated initial inflection point. In this configuration, the inflection point in the measured voltage change may correspond to a peak (differential value peak) in differential values when the differential values of a voltage measured by setting a charge/discharge capacity of the secondary battery or a measurement time as a variable are calculated.

In the charge control devices or the like having the configuration according to the embodiments of the present disclosure, the charge control unit may control an application voltage to the electrode at a time of charge of the secondary battery based on an evaluation result of the degree of degradation of the second battery in the degradation degree detection and evaluation unit. Further, in the charge state estimation method for the secondary battery according to the embodiment of the present disclosure, the application voltage to the positive electrode at a time of charge of the secondary battery may be controlled based on an evaluation result of the degree of degradation of the secondary battery.

In a charge state estimation device for a secondary battery according to an embodiment of the present disclosure, a charge state estimation device in a charge state estimation method for a secondary battery according to an embodiment of the present disclosure, and a charge state estimation device in a secondary battery device of a second form according to an embodiment of the present disclosure (hereinafter, the charge state estimation devices are also collectively referred to as charge state estimation devices or the like according to the embodiments of the present disclosure), the correction unit may correct the relation between the state of charge and the open circuit voltage based on an evaluation result of the degree of degradation of the second battery in the degradation degree detection and evaluation unit. Further, in a charge state estimation method for a secondary battery according to an embodiment of the present disclosure, the relation between the state of charge and the open circuit voltage may be corrected based on an evaluation result of the degree of degradation of the second battery.

In the charge state estimation devices or the like according to the embodiments of the present disclosure, the degradation degree detection and evaluation unit may measure a voltage change between the positive and negative electrodes at a time of charge or discharge of the secondary battery, calculate an inflection point in the measured voltage change, and calculate the degree of degradation of the secondary battery based on a difference between the inflection point and a precalculated initial inflection point. The correction unit may correct the relation between the state of charge and the open circuit voltage based on the degree of degradation of the second battery calculated by the degradation degree detection and evaluation unit. In this case, the difference may be based on a relation between the inflection point in the measured voltage change and the precalculated initial inflection point. In this configuration, the inflection point in the measured voltage change may correspond to a peak (differential value peak) in differential values when the differential values of a voltage measured by setting a charge/discharge capacity of the secondary battery or a measurement time as a variable are calculated.

In the charge state estimation method for the secondary battery according to the above-described preferred embodiment of the present disclosure, a voltage change between the positive and negative electrodes may be measured at a time of charge or discharge of the secondary battery, an inflection point in the measured voltage change may be calculated, and the degree of degradation of the secondary battery may be calculated based on a difference between the inflection point and a precalculated initial inflection point. The relation between the state of charge and the open circuit voltage may be corrected based on the degree of degradation of the second battery. In this case, the difference may be based on a relation between the inflection point in the measured voltage change and the precalculated initial inflection point. In this configuration, the inflection point in the measured voltage change may correspond to a peak (differential value peak) in differential values when the differential values of a voltage measured by setting a charge/discharge capacity of the secondary battery or a measurement time as a variable are calculated.

In the charge control device for the secondary battery, the charge control method for the secondary battery, the charge state estimation device for a secondary battery, the charge state estimation method for the secondary battery, or the secondary battery devices of the first and second forms according to the above-described preferred embodiments of the present disclosure, the negative electrode may be formed of a material in which an inflection point is present in a potential change (corresponding to a differential curve of an OCV curve) at the time of charge or discharge of the secondary battery and the positive electrode may be formed of a material in which no inflection point is present in the potential change (corresponding to a differential curve of an OCV curve). In this case, the secondary battery may include a lithium-ion secondary battery, the negative electrode may be formed of graphite, and the positive electrode may be formed of lithium iron phosphate.

The secondary battery, the material of the negative electrode, and the material of the positive electrode are not limited thereto. Examples of the secondary battery include a magnesium-ion secondary battery and an aluminum-ion secondary battery. Examples of the material of the negative electrode include transition metal oxides (for example, iron oxide (Fe₂O₃), nickel oxide (NiO), manganese oxide (Mn₂O₃)) and, typical metallic oxides (for example, tin oxide (SnO₂)). Examples of the material of the positive electrode include lithium manganese phosphate (LiMnPO₄), lithium cobalt phosphate (LiCoPO₄), lithium cobalt oxide (LiCoO₂), NCA ternary system, and NCM ternary system.

In a degradation degree estimation device of a first form for a secondary battery according to an embodiment of the present disclosure, a secondary battery device of a third form according to an embodiment of the present disclosure, or a degradation degree estimation method of a first form for a secondary battery according to an embodiment of the present disclosure (hereinafter, the devices and the method are also collectively referred to as “the degradation degree estimation device of the first form and the like for the secondary battery according to the embodiments of the present disclosure”), the inflection point in the measured voltage change may correspond to a peak in differential values when the differential values of a voltage measured by setting a charge/discharge capacity of the secondary battery as a variable are calculated. In this case, a position of the peak of the differential value corresponding to the inflection point in the measured voltage change may be a value of a discharge capacity of the secondary battery for which a full charge state of the secondary battery is a start time point. Further, in the degradation degree estimation device and the like of the first form according to the above-described preferred embodiments of the present disclosure, the degree of degradation of the secondary battery may be expressed by a change from an initial capacity calculated from, for example, an initial potential change (initial OCV curve). Based on the evaluation result of the degree of degradation of the secondary battery in the degradation degree detection and evaluation unit, the degradation degree detection and evaluation unit may control the voltage application state to the electrode at the time of charge of the secondary battery. Based on the evaluation result of the degree of degradation of the secondary battery in the degradation degree detection and evaluation unit, the degradation degree detection and evaluation unit may correct the relation between the state of charge and the open circuit voltage.

In a degradation degree estimation device of a second form for a secondary battery according to an embodiment of the present disclosure, a secondary battery device of a fourth form according to an embodiment of the present disclosure, or a degradation degree estimation method of a second form for a secondary battery according to an embodiment of the present disclosure (hereinafter, the devices and the method are also collectively referred to as “the degradation degree estimation device of the second form and the like for the secondary battery according to the embodiments of the present disclosure”), the charge/discharge history data may include at least a discharge rate, a temperature of the secondary battery, and a state of charge. In the degradation degree estimation device of the second form and the like for the secondary battery according to the preferred embodiments of the present disclosure, the degree of degradation of the secondary battery may be expressed by a change from an initial capacity calculated from, for example, an initial potential change (initial OCV curve). Based on the evaluation result of the degree of degradation of the secondary battery in the degradation degree detection and evaluation unit, the degradation degree detection and evaluation unit may control the voltage application state to the electrode at the time of charge of the secondary battery. Based on the evaluation result of the degree of degradation of the secondary battery in the degradation degree detection and evaluation unit, the degradation degree detection and evaluation unit may correct the relation between the state of charge and the open circuit voltage.

In the degradation degree estimation device of the first form and the like for the secondary battery and the degradation degree estimation device of the second form and the like for the secondary battery according to the above-described preferred embodiments of the present disclosure, as described above, the negative electrode may be formed of a material in which an inflection point is present in a potential change at the time of charge or discharge of the secondary battery and the positive electrode may be formed of a material in which no inflection point is present in the potential change. In this case, the secondary battery may include a lithium-ion secondary battery, the negative electrode may be formed of graphite, and the positive electrode may be formed of lithium iron phosphate. The secondary battery, the material of the negative electrode, and the material of the positive electrode are not limited thereto, but the above-described various materials may be used.

### First Embodiment

A first embodiment of the present disclosure relates to a charge control device for a secondary battery, a charge control method for the secondary battery, and a secondary battery device of a first form.

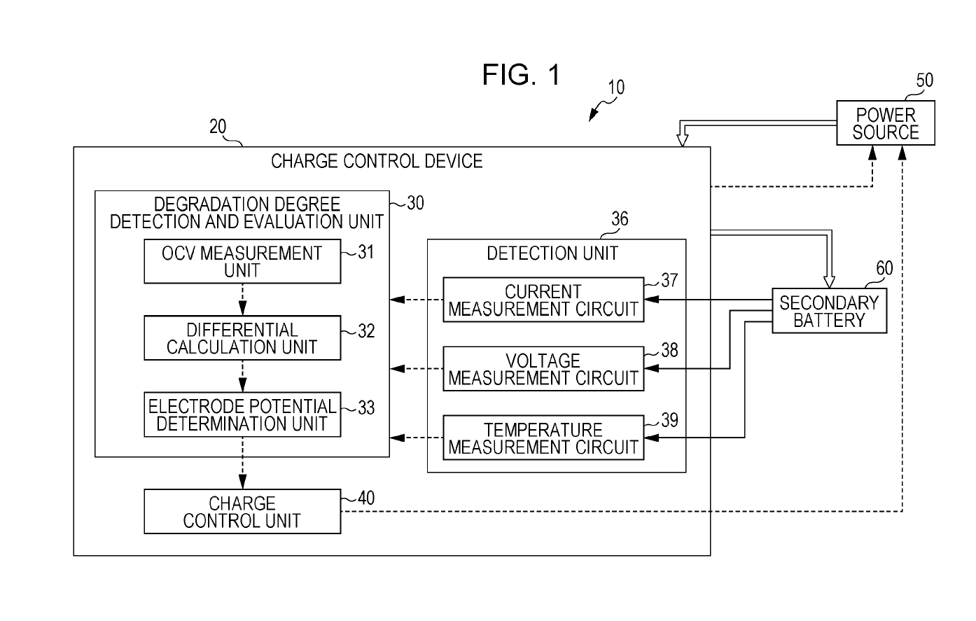

A secondary battery device 10 according to the first embodiment is a secondary battery device that includes a secondary battery (also referred to as a secondary battery cell) 60 including positive and negate electrodes and a charge control device 20 controlling charge of the secondary battery 60. The charge control device 20 for the secondary battery according to the first embodiment or the charge control device 20 for the secondary battery in the secondary battery device 10 according to the first embodiment is a charge control device that controls a charge of the secondary battery (specifically, in the embodiment, a lithium-ion secondary battery) 60 having positive and negative electrodes, as illustrated in the block diagram of FIG. 1. The charge control device 20 includes: (A) a degradation degree detection and evaluation unit 30 that detects and evaluates the degree of degradation of the secondary battery; and (B) a charge control unit 40.

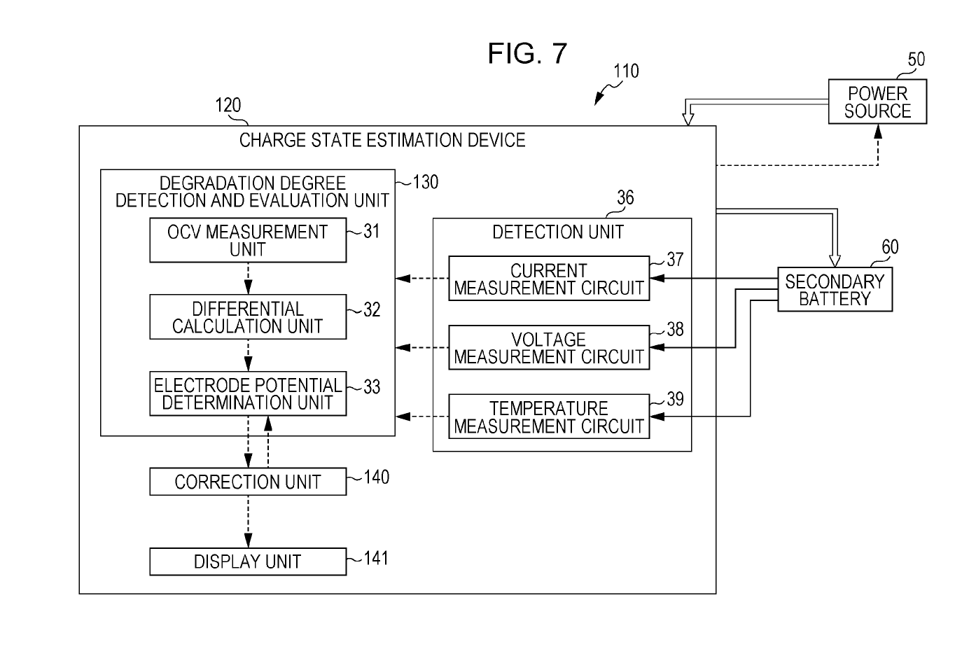

In FIG. 1 and FIGS. 7, 9, and 11 to be described below, a flow of data or a processing signal is indicated by a dotted line, a flow of a measurement amount is indicated by a solid line, and flow of power is indicated by a double line.

The degradation degree detection and evaluation unit 30 includes an OCV measurement unit 31, a differential calculation unit 32, and an electrode potential determination unit 33. The charge control device 20 further includes a detection unit 36. The detection unit 36 includes a current measurement circuit 37, a voltage measurement circuit 38, and a temperature measurement circuit 39. The degradation degree detection and evaluation unit 30 and the charge control unit 40 themselves can be configured by existing circuits.

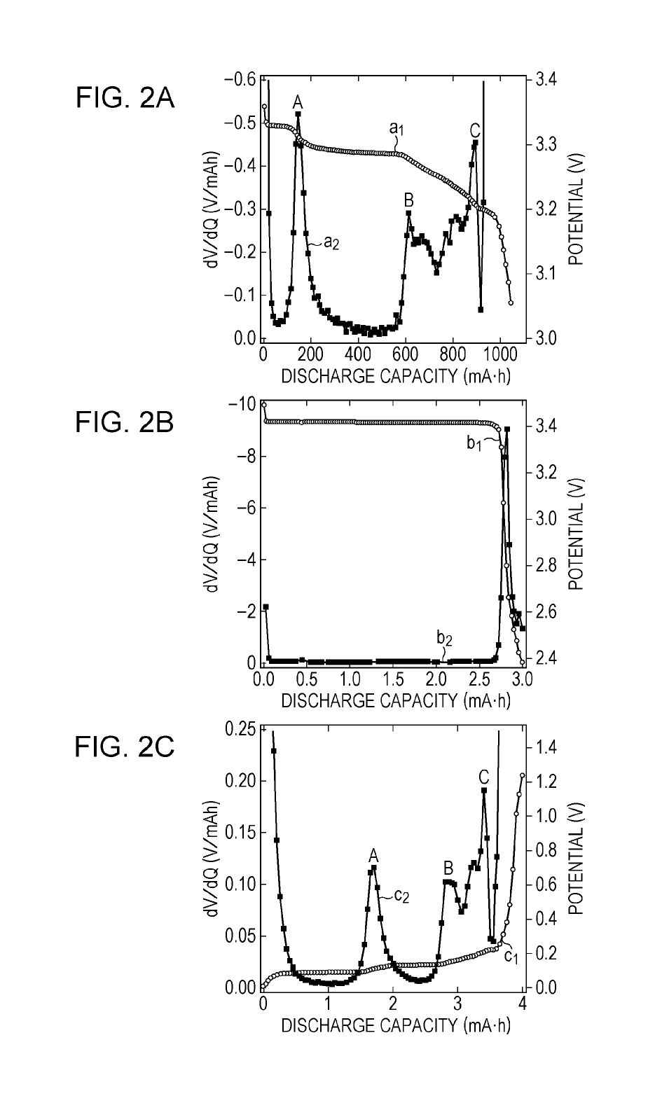

A test battery is manufactured from a positive electrode and an opposite electrode formed of lithium (Li) which are included in the secondary battery 60, the test battery is discharged based on an intermittent discharge to be described below, and a potential of the positive electrode at the time of the discharge is measured. The measurement result is indicated in “b₁” in FIG. 2B. The potential measurement result of the positive electrode at the time of the discharge of the test battery is referred to as an “initial positive electrode OCV curve” for convenience. Further, a test battery is manufactured from a negative electrode and an opposite electrode formed of lithium (Li) which are included in the secondary battery 60, the test battery is discharged based on the intermittent discharge to be described below, and a potential of the negative electrode at the time of the discharge is measured. The measurement result is indicated by “c₁” in FIG. 2C. The potential measurement result of the negative electrode at the time of the discharge of the test battery is referred to as an “initial negative electrode OCV curve” for convenience. Inflection points are calculated on differential curves of the initial positive electrode OCV curve and the initial negative electrode OCV curve. The inflection points correspond to differential value peaks in these curves. The inflection point obtained from the different curve of the initial positive electrode OCV curve and/or the initial negative electrode OCV curve corresponds to an “initial inflection point.” The same applies also to the following description. Further, (dV/dQ) curve based on the initial positive electrode OCV curve and (dV/dQ) curve [where the (dV/dQ) curve corresponds to a differential curve of the OCV curve] based on the initial negative electrode OCV curve are indicated by “b₂” of FIG. 2B and “c₂” of FIG. 2C. In FIGS. 2A to 2C, the horizontal axis represents a discharge capacity (units: milliampere·time) at the time of discharge and the vertical axis represents an open circuit voltage (OCV, units: volt) and (dV/dQ) (units: volt/milliampere·time). A degraded actual state of the secondary battery is analyzed based on the initial positive electrode OCV curve and the initial negative electrode OCV curve obtained in this way.

In the first embodiment, the negative electrode is formed of a material in which an inflection point is present in a potential change (corresponding to a differential curve of the OCV curve) when the secondary battery 60 is charged or discharged. The positive electrode is formed of a material in which no inflection point is present in a potential change (corresponding to a differential curve of the OCV curve). Specifically, as described above, the secondary battery 60 is configured by a lithium-ion secondary battery. The negative electrode is formed of graphite and the positive electrode is formed of lithium iron phosphate.

In the example illustrated in FIG. 2B, since the positive electrode is formed of lithium iron phosphate, no differential value peak is present on the (dV/dQ) curve b₂ during a stable discharge period before an over-discharge state. On the other hand, in the example illustrated in FIG. 2C, since the negative electrode is formed of graphite, three differential value peaks (A, B, and C) are present on the (dV/dQ) curve c₂ during a stable discharge period before the over-discharge state. Such a phenomenon is produced because when the negative electrode is formed of graphite, Li is gradually adsorbed to graphite at various stage structures.

A charge/discharge capacity [discharge capacity (Q)] or a measurement time [discharge time (integrated value)] at the inflection points obtained from the precalculated initial positive electrode OCV curve and the precalculated initial negative electrode OCV curve, and further, the differential curves of the initial positive electrode OCV curve and/or the initial negative electrode OCV curve are stored in the electrode potential determination unit 33. The inflection points correspond to differential value peaks on these curves.

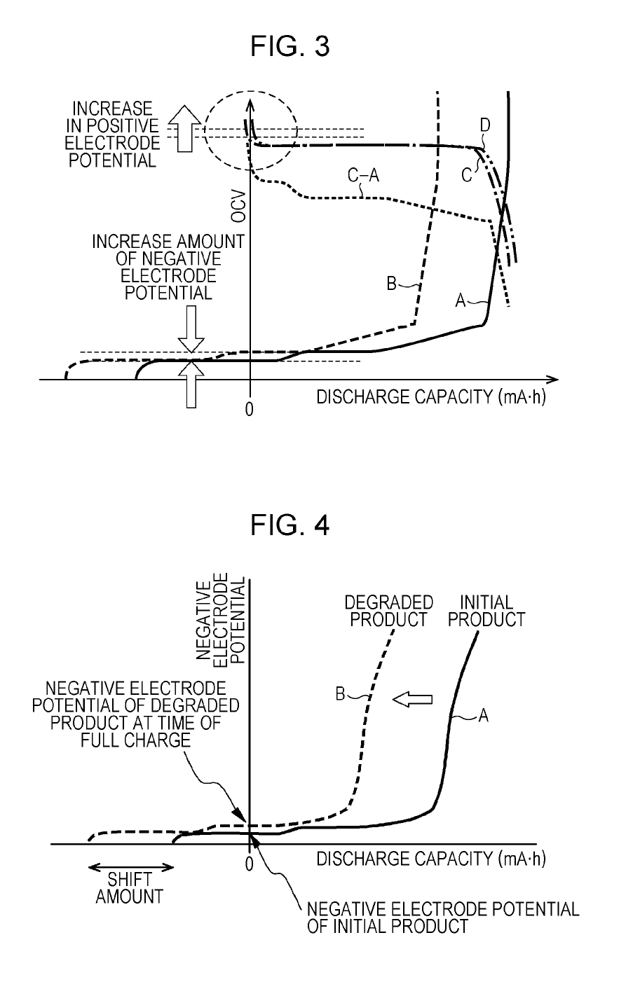

FIG. 3 is a graph schematically showing how the potentials of the positive and negative electrodes at the time of discharge vary due to degradation of the secondary battery and how the open circuit voltage (OCV) varies, that is, a schematic diagram illustrating the initial positive electrode OCV curve, the initial negative electrode OCV curve, and a positive electrode OCV curve and a negative electrode OCV curve (also referred to as a “positive electrode OCV curve after the degradation” and a “negative electrode OCV curve after the degradation”) of the degraded secondary battery under an actual use environment. FIG. 4 is an expanded graph schematically showing how the potential of the negative electrode varies at the time of discharge due to the degradation of the secondary battery, that is, an expanded schematic diagram illustrating the initial negative electrode OCV curve and the negative electrode OCV curve after the degradation.

In FIGS. 3 and 4, a curve “A” indicates the initial negative electrode OCV curve and a curve “B” indicates an example of the negative electrode OCV curve after the degradation. In FIG. 3, a curve “C” indicates the initial positive electrode OCV curve and a curve “D” indicates an example of the positive electrode OCV curve after the degradation. In FIG. 3, a curve “C-A” indicates a curve indicates a curve obtained by subtracting the initial negative electrode OCV curve from the initial positive electrode OCV curve. Here, in FIGS. 3 and 4, the horizontal axis represents a discharge capacity (units: milliampere·time) at the time of discharge and the vertical axis represents an open circuit voltage (OCV, units: volt). In FIG. 3, the curves C and A overlapping each other in a region in which the discharge capacity is large are illustrated and the curves D and B overlapping each other in a region in which the discharge capacity is large are illustrated. In practice, however, the curves C and D are located considerably above the curves A and B. For convenience, since the vertical axis of FIG. 3 is expressed so as to be compact, these curves are shown as the overlapping curves. The discharge of the test battery starts at “0” of the discharge capacity. In FIGS. 3 and 4, in regard to the discharge capacity, the curves A and B extending up to the negative region are illustrated. In practice, however, the portions of the curves A and B in the negative region of the discharge capacity are imaginary. The portions of the curves A and B in the negative region of the discharge capacity mean that a portion (a region protruding to the negative region) corresponding to the negative electrode is not used for Li adsorption since an acceptable Li amount (capacity) of the negative electrode is excessive with respect to a Li amount (capacity) supplied from the positive electrode.

As illustrated in FIGS. 3 and 4, in the secondary battery degraded due to several repetitions of charge and discharge, the negative electrode OCV curve B after the degradation is shifted in a direction in which the discharge capacity is reduced, compared to the initial negative electrode OCV curve A. Such shift is referred to “OCV curve shift” for convenience. As a result of the occurrence of the OCV curve shift, the potential of the negative electrode at the time of full charge of the degraded secondary battery (degraded product) is higher than the potential of the negative electrode at the time of full charge of the initial secondary battery (initial product).

As described above, generally, according to the CC-CV method, the secondary battery is fully charged by first performing constant-current charge, and then performing the constant-voltage discharge. Then, since the secondary battery is charged by setting the full-charge voltage (cell voltage) at the time of charge of the secondary battery to be constant, the increase in the potential of the negative electrodes may result in the increase in the potential of the positive electrode. As a consequence, since a side reaction (oxidation of electrolyte, structure degradation of a positive-electrode active material, or the like) occurs in the positive electrode, there is a concern that capacity degradation of the secondary battery may accelerate.

Specific operations of the charge control device 20 and the secondary battery device 10 according to the first embodiment and the charge control method for the secondary battery according to the first embodiment capable of charging the secondary battery based on an optimum condition without acceleration of the capacity degradation of the secondary battery will be described below.

In the charge control device 20 according to the first embodiment, the charge control unit 40 controls a voltage application state to an electrode (specifically, the positive electrode in the first embodiment) at the time of the charge of the secondary battery 60 based on an evaluation result of the degree of degradation of the secondary battery 60 in the degradation degree detection and evaluation unit 30. Specifically, a voltage to be applied to the positive electrode is determined.

The charge control method for the secondary battery according to the first embodiment detects and evaluates the degree of degradation of the secondary battery and controls a voltage application state to the electrode (specifically, the positive electrode in the first embodiment) at the time of full charge of the secondary battery based on the evaluation result of the degree of degradation of the secondary battery. Specifically, a voltage to be applied to the positive electrode is determined.

Therefore, the degradation degree detection and evaluation unit 30 measures a voltage change between the positive and negative electrodes at the time of the charge or the discharge (in the first embodiment, specifically, at the time of the discharge) of the secondary battery 60 (that is, measures the OCV and obtains the OCV curve), calculates an inflection point in the measured voltage change, and calculates the degree of degradation of the secondary battery 60 based on a difference between the inflection point and a precalculated initial inflection point. Then, the charge control unit 40 sets (determines) the potential of the positive electrode to be applied at the time of the charge of the secondary battery 60 based on the degree of degradation of the secondary battery 60 calculated by the degradation degree detection and evaluation unit 30.

Here, the difference is based on a relation between the inflection point in the measured voltage change (the differential curve of the OCV curve) and the precalculated initial inflection point. As described above, the inflection point in the measured voltage change (the differential curve of the OCV curve) corresponds to a peak (differential value peak) in differential values when the differential values of the voltage measured using the charge/discharge capacity of the secondary battery 60 or a measurement time as a variable are calculated. Specifically, the difference is a discharge capacity difference or a discharge time difference.

More specifically, the charge control device 20 converts power supplied from the power source 50 into a voltage of a predetermined current and charges the secondary battery 60 configured by a lithium-ion secondary battery under constant-current and constant-voltage control. After the charge control device 20 confirms that the power source 50 operates at every predetermined number of cycles or at intervals of a predetermined elapsed time, the charge control device 20 controls the operation of the power source 50 under a charge termination condition recorded in the charge control device 20 and fully charges the secondary battery 60.

Subsequently, discharge of the secondary battery 60 is performed according to a discharge method based on an intermittent discharge to be described below. Although not described, alternatively, an intermittent discharge may be performed only before and after a differential value peak in a (dV/dQ) curve or a (dV/dt) curve, or low-rate discharge may be performed.

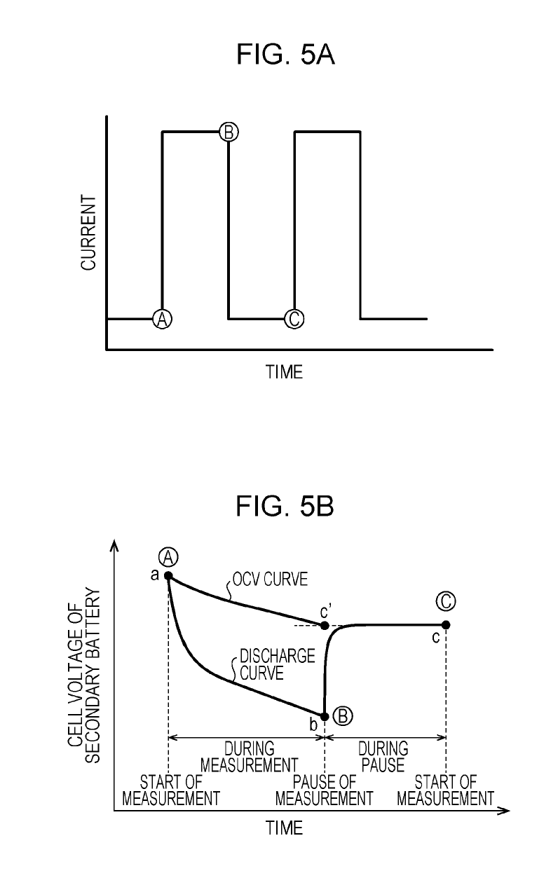

Thus, an open circuit voltage (open terminal voltage, OCV) curve can be obtained by the OCV measurement unit 31. FIGS. 5A and 5B are a conceptual diagram illustrating the intermittent discharge and a diagram illustrating an example of a relation between the intermittent discharge and the open circuit voltage (OCV) curve. Specifically, the secondary battery 60 is set to be in a non-load state. As illustrated in FIG. 5A, constant-current discharge starts at time “A” and the constant-current discharge is paused after a given time elapses. This time point is indicated by time “B” in FIG. 5A. Subsequently, after a predetermined time elapses, the open circuit voltage (OCV) is measured at time “C.” On the other hand, as illustrated in FIG. 5B, “a” indicates an open circuit voltage measured at the time “A.” Further, “b” indicates a voltage which is measured at the time “B” immediately after the discharge. Furthermore, “c” indicates an open circuit voltage measured at time “C.” The open circuit voltages are measured a plurality of times in this way and the open circuit voltage circuit curve (OCV curve) can be obtained by binding the open circuit voltages “a,” “c,” and the like during an integration time other than the pause time. An open circuit voltage “c′” at time B is a voltage that is obtained through parallel translation of the open circuit voltage “c” by the pause time at time C to the left to draw the OCV curve during a time other than the pause time. The horizontal axis of FIG. 5B represents a time, but may alternatively represent a discharge capacity (Q).

Based on the open circuit voltage curve (OCV curve) obtained by the OCV measurement unit 31, the differential calculation unit 32 calculates a differential curve (where the x axis represents the discharge capacity (Q) and the y axis represents dV/dQ) in which the discharge capacity is set as a variable or a differential curve (where the x axis represents a time (t) and the y axis represents dV/dt) at a discharge time (integrated value). At this time, when the time (dt) is set to about 10 seconds, a differential value peak can easily be detected. An example of the open circuit voltage curve (OCV curve) is indicated by “a₁” in FIG. 2A and a differential curve in which the discharge capacity is set as a variable is indicated by “a₂” in FIG. 2A. Three differential value peaks (A, B, and C) are present on the (dV/dQ) curve a₂. That is, during a stable discharge period before the over-discharge state, the three differential value peaks (A, B, and C) are present on the (dV/dQ) curve a₂.

Alternatively, by performing low-rate discharge, the open circuit voltage curve (OCV curve) can be also obtained. In this case, a discharge rate is preferably set to about 0.1 C. When the discharge rate is set to be too large, there is a concern that it is difficult to detect the differential value peak on the (dV/dQ) curve or the (dV/dt) curve. Depending on a case, the open circuit voltage curve (OCV curve) can be also obtained, when the secondary battery 60 is connected to a load.

Hereinafter, detailed operations of the degradation degree detection and evaluation unit 30 and the charge control unit 40 based on the above-described intermittent discharge will be described.

The current measurement circuit 37 measures a discharge current flowing in the secondary battery 60 and transmits the measurement result to the degradation degree detection and evaluation unit 30. The voltage measurement circuit 38 measures a voltage of the secondary battery 60 and transmits the measurement result to the degradation degree detection and evaluation unit 30. The temperature measurement circuit 39 measures a surface temperature of the secondary battery 60 and transmits the measurement result to the degradation degree detection and evaluation unit 30.

At the time discharge of the secondary battery, the OCV measurement unit 31 calculates the OCV curve of the secondary battery 60 from data (that is, the measurement result of the voltage change between the positive and negative electrodes, in other words, the measurement result of the OCV) from the detection unit 36 according to an existing method and stores the OCV curve in the OCV measurement unit 31. After the discharge and before charge start of the secondary battery, the differential calculation unit 32 calculates an inflection point of the differential curve of the OCV curve obtained by the OCV measurement unit 31 according to an existing method. That is, based on the OCV curve obtained by the OCV measurement unit 31 and stored in the OCV measurement unit 31, the differential calculation unit 32 calculates a differential curve (where the x axis represents the discharge capacity (Q) and the y axis represents dV/dQ) in which the discharge capacity is set as a variable or a differential curve (where the x axis represents a time (t) and the y axis represents dV/dt) at a discharge time (integrated value). Further, a differential value peak on the (dV/dQ) curve or the (dV/dt) curve is calculated according to an existing method, and the discharge capacity or the discharge time corresponding to the differential value peak is calculated. Based on the position of the calculated differential value peak (the value of a variable such as a charge/discharge capacity or the measurement time obtained at the differential value peak) and the charge/discharge capacity [discharge capacity (Q)] or the measurement time [discharge time (integrated value)] at the initial inflection point stored in the electrode potential determination unit 33, the electrode potential determination unit 33 corrects the initial negative electrode OCV curve and calculates an increase amount of the negative electrode potential from the corrected initial negative electrode OCV curve. In this way, the electrode potential determination unit 33 can calculate the negative electrode potential at the time of full charge. Thus, the differential calculation unit 32 and the electrode potential determination unit 33 calculate the inflection point (which corresponds to the discharge capacity or the discharge time corresponding to the differential value peak and one or all of “A,” “B,” and “C” in FIG. 2A) in the measured voltage change and calculate the degree of degradation of the secondary battery 60 based on a difference (specifically, a discharge capacity difference or a discharge time difference) between the calculated inflection point and a precalculated initial inflection point (which corresponds to a differential value peak on the initial negative electrode OCV curve and one or all of “A,” “B,” and “C” in FIG. 2C). Here, the calculated increase amount of the negative potential corresponds to the degree of degradation of the secondary battery 60.

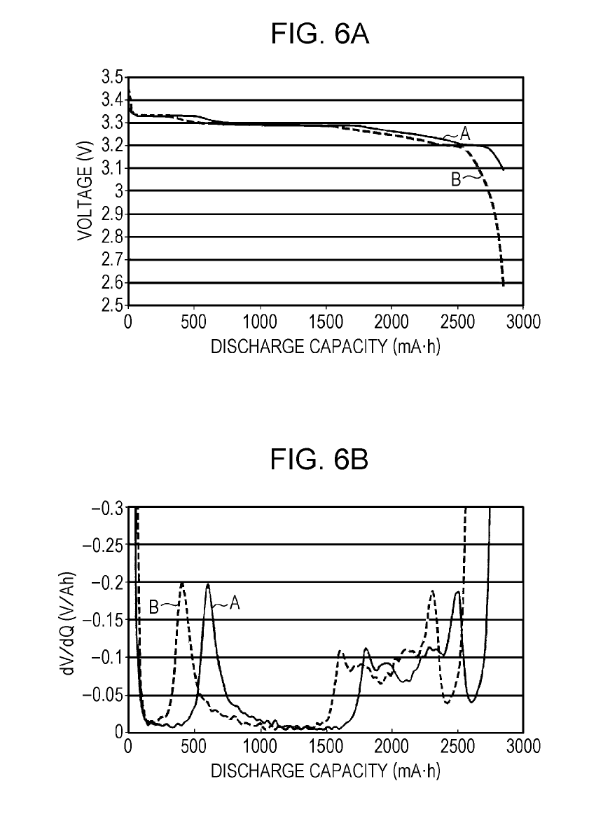

FIGS. 6A and 6B are a graph measuring how the open circuit voltage (OCV) varies at the time of the discharge due to the degradation of the secondary battery and a graph illustrating (dV/dQ) calculated from the obtained open circuit voltage (OCV) curve, respectively. In FIGS. 6A and 6B, “A” indicates measurement data of the initial secondary battery and “B” indicates measurement data of the degraded secondary battery.

Data regarding the increase amount of the negative electrode potential corresponding to the degree of degradation of the secondary battery 60 is transmitted to the charge control unit 40. The charge control unit 40 sets (determines) the positive electrode potential (or a full-charge voltage) in consideration of the increase amount of the negative electrode potential (the negative electrode potential at the time of full charge) so that the potential (or the full-charge voltage) of the positive electrode to be applied at the time of the charge of the secondary battery 60 does not increase. That is, the secondary battery 60 is charged using, as the full-charge voltage, a voltage obtained by reducing the increase amount of the negative electrode potential from an initial full-charge voltage at the start time of use of the secondary battery. Further, the potential (or the full-charge voltage) of the positive potential may be set (determined) in consideration of the surface temperature of the secondary battery received from the temperature measurement circuit 39.

The charge control device 20 also sets a current voltage at the time of an operation in a constant-voltage region and a charge current at the time of an operation in a constant-current region. Further, the charge control device 20 counts the number of cycles of charge and discharge performed from the start of use of the secondary battery 60 based on the data received from the current measurement circuit 37. Further, the charge control device 20 measures an elapsed time from the start of use of the secondary battery 60.

In the first embodiment, as described above, the voltage application state to the electrode at the time of the charge of the secondary battery is controlled based on the evaluation result of the degree of degradation of the secondary battery, specifically, the increase amount of the negative electrode potential. That is, the potential (or the full-charge voltage) of the positive electrode is set (determined) based on the increase amount (the negative electrode potential at the time of the full charge) of the negative electrode potential so that the potential (or the full-charge voltage) of the positive electrode to be applied at the time of the charge of the secondary battery does not increase. Thus, in the first embodiment, the degree of degradation of the secondary battery is determined quantitatively under an actual use environment and a next charge voltage can be set, thereby causing the positive electrode potential at the time of the full charge to remains constant in a normal state. As a result, the capacity degradation caused due to a side reaction (oxidation of electrolyte, structure degradation of a positive-electrode active material, or the like) in the positive electrode can be suppressed. Accordingly, an actual use period (for example, a period in which a capacity maintenance ratio reaches 70% or less) of the secondary battery can be prolonged. On the other hand, since the positive electrode potential is not set to be too low, the battery capacity can be used at a maximum in a normal state. That is, while the lifetime of the secondary battery can be prolonged, the battery capacity can be efficiently used.

The electrode potential determination unit 33 may perform the following process in addition to the above-described process or may independently perform separately from the above-described process. That is, for example, the electrode potential determination unit 33 calculates a discharge capacity difference (ΔQ₂) or a discharge time difference (ΔT₂) between two differential value peaks (for example, the differential value peaks A and C) among the three differential value peaks (A, B, and C) present on the (dV/dQ) curve a₂ illustrated in FIG. 2A. Further, the electrode potential determination unit 33 calculates a difference between discharge capacity differences (ΔQ₁) or discharge time differences (ΔT₁) of two differential value peaks (for example, the differential value peaks A and C) among the three differential value peaks (A, B, and C) present on the (dV/dQ) curve c₂ based on the initial negative electrode OCV curve illustrated in FIG. 2C. That is, (ΔQ₁−ΔQ₂) or (ΔT₁−ΔT₂) is calculated. Further, (ΔQ₁−ΔQ₂) or (ΔT₁−ΔT₂) is referred to as the “degree of contraction of the negative electrode” for convenience. The significant value (>0) of the degree of contraction of the negative electrode serves as an index of a decrease in the charge/discharge capacity of the secondary battery 60. That is, the degree of contraction of the negative electrode corresponds to the evaluation result of the degree of degradation of the secondary battery 60. Accordingly, the degree of contraction of the negative electrode is evaluated based on differential value peak information extracted from the (dV/dQ) curve acquired from the secondary battery degraded in the actual use and illustrated in FIG. 2A and differential value peak information based on the initial negative electrode OCV curve. Thus, the charge control unit 40 can control the application voltage to the positive electrode at the time of the charge of the secondary battery 60 based on the calculated degree of contraction (ΔQ₁−ΔQ₂) or (ΔT₁−ΔT₂) of the negative electrode, that is, based on the evaluation result (the degree of contraction of the negative electrode) of the degree of degradation of the secondary battery 60 in the degradation degree detection and evaluation unit 30.

By the way, when the negative electrode is formed of graphite and the positive electrode is formed of lithium iron phosphate, as described above and illustrated in FIGS. 2B and 2C, an inflection point is present on the differential curve of the OCV curve of the negative electrode and no inflection point is present on the differential curve of the OCV curve of the positive electrode. Therefore, it is not necessary to consider the appearance of the differential value peak originating from the positive electrode. However, when a positive electrode material in which an inflection point is present in the differential curve of the OCV curve of the positive electrode is combined with a negative electrode material in which an inflection point is present in the differential curve of the OCV curve of the negative electrode, it is necessary to determine whether the differential value peak is the differential value peak originating from the positive electrode or the differential value peak originating from the negative electrode. Even in this case, by acquiring the data illustrated in FIGS. 2B and 2C in advance, it is possible to obtain the differential value peak originating from the positive electrode and the differential value peak originating from the negative electrode. Therefore, the differential value peak originating from the positive electrode and the differential value peak originating from the negative electrode can be separated from, for example, (dV/dQ) calculated from the open circuit voltage (OCV) curve illustrated in FIG. 2A. The same applies also to second to fourth embodiments to be described below.

For example, even when a potential change peculiar to the OCV curve of the negative electrode and a potential change peculiar to the OCV curve of the negative electrode of the secondary battery is reflected to the OCV curve or the discharge curve of the battery pack (assembled batteries) in which a plurality of secondary batteries are connected in series or in parallel, the above-described charge control method for the secondary battery can be applied also to the battery pack (assembled batteries). For example, by estimating a change in the voltage change for a given time, it is possible to calculate how the OCV curve of the negative electrode is moved from the initial negative electrode OCV curve or how the degree of contraction of the negative electrode is produced. The same applies also to second to fourth embodiments to be described below.

### Second Embodiment

A second embodiment of the present disclosure relates to a charge state estimation device for a secondary battery, a charge state estimation method for the secondary battery, and a secondary battery device of a second form.

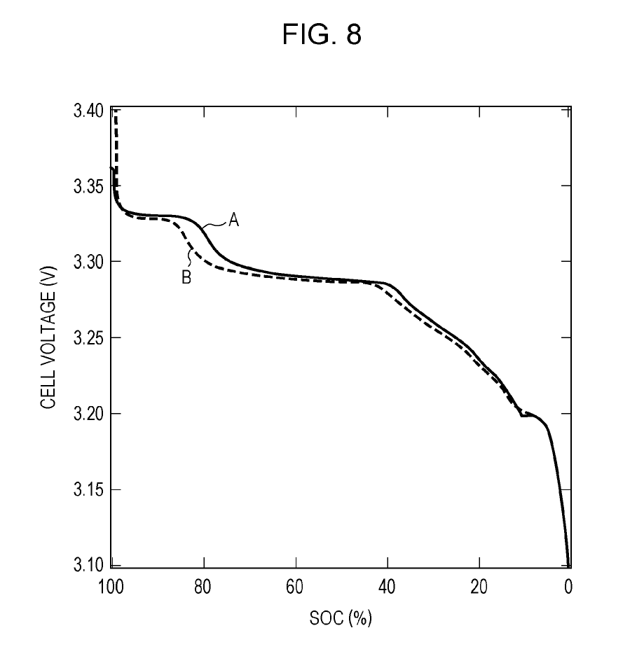

When a full-charge capacity (maximum charge capacity: full charge capacity) is assumed to be 100%, there is a given correlation between a state of charge (SOC) [%] and an open circuit voltage (OCV). Therefore, the state of charge (SOC) may be determined through calculation based on measured results on the open circuit voltage (OCV). As described above, when charge and discharge are repeated, the secondary battery is degraded, and consequently the open circuit voltage curve (OCV curve) at the time of discharge is shifted. As a result, as illustrated in FIG. 8, in the degraded secondary battery, there is a deviation in the correlation between a measured open circuit voltage (OCV) and the state of charge (SOC). In FIG. 8, “A” indicates an initial product and “B” indicates a degraded product. The horizontal axis represents the SOC (units: %) when a cell voltage of 3.1 volts is set as a reference. The vertical axis represents an OCV measurement result (units: volt).

A secondary battery device 110 according to the second embodiment is a secondary battery device that includes a secondary battery 60 including positive and negative electrodes and a charge state estimation device 120 for the secondary battery 60. As illustrated in the block diagram of FIG. 7, the charge state estimation device 120 for the secondary battery according to the second embodiment or the charge state estimation device 120 for the secondary battery in the secondary battery device 110 according to the second embodiment is a charge state estimation device for the secondary battery 60 having the positive and negative electrodes and includes: (A) a degradation degree detection and evaluation unit 130 that detects and evaluates the degree of degradation of the secondary battery 60; and (B) a correction unit 140 that corrects a relation between the state of charge and the open circuit voltage.

Based on an evaluation result of the degree of degradation of the secondary battery 60 in the degradation degree detection and evaluation unit 130, the correction unit 140 corrects the relation between the state of charge and the open circuit voltage.

As in the first embodiment, the degradation degree detection and evaluation unit 130 includes an OCV measurement unit 31, a differential calculation unit 32, and an electrode potential determination unit 33. The charge state estimation device 120 further includes a detection unit 36. The detection unit 36 includes a current measurement circuit 37, a voltage measurement circuit 38, and a temperature measurement circuit 39. The charge state estimation device 120 further includes a display unit 141 that displays the value of the calculated state of charge (SOC). The degradation degree detection and evaluation unit 130, the correction unit 140, and the display unit 141 themselves can be configured by existing circuits and an existing display device. Even in the second embodiment, the negative electrode is formed of graphite and the positive electrode is formed of lithium iron phosphate, as in the first embodiment.

In the second embodiment, or third and fourth embodiments to be described below, for example, the potentials of the positive and negative electrodes are changed due to the degradation of the secondary battery at the time of discharge, as described in the first embodiment. The way how the potentials of the positive and negative electrodes at the time of the discharge vary due to degradation of the secondary battery and the way how the open circuit voltage (OCV) varies are the same as the ways described with reference to FIGS. 3 and 4 in the first embodiment. In the secondary battery degraded due to several repetitions of charge and discharge, shift of the OCV curve occurs, and consequently the potential of the negative electrode at the time full charge of a degraded product is higher than the potential of the negative electrode at the time of full charge of an initial product, as in the first embodiment.

When the shift of the OCV curve occurs, the relation between the state of charge and the open circuit voltage is changed. Therefore, it is possible to obtain a change amount (a correction amount for the state of charge) of the relation between the state of charge and the open circuit voltage by correcting the relation between the open circuit voltage (OCV) and the state of charge (SOC) obtained in the initial product based on differential value peak information extracted from the (dV/dQ) curve illustrated in FIG. 2A and acquired in the secondary battery degraded in actual use and differential value peak information based on the initial negative electrode OCV curve.

Specific operations of the charge state estimation device 120 and the secondary battery device 110 capable of improving estimation accuracy of the SOC based on OCV measurement according to the second embodiment will be described below. Further, a charge control method for a secondary battery capable of detecting and evaluating the degree of gradation of the secondary battery 60 and correcting the relation between the state of charge and the open circuit voltage based on the evaluation result of the degree of degradation of the secondary battery 60 will be described below as a charge control method for a secondary battery according to the second embodiment.

Here, in the charge state estimation device 120 according to the second embodiment, the correction unit 140 corrects the relation between the state of charge and the open circuit voltage based on the evaluation result of the degree of degradation of the secondary battery 60 in the degradation degree detection and evaluation unit 130. The charge state estimation method according to the second embodiment includes correcting the relation between the state of charge and the open circuit voltage based on the evaluation result of the degree of degradation of the secondary battery 60.

Therefore, the degradation degree detection and evaluation unit 130 measures a voltage change between the positive and negative electrodes at the time of charge or discharge (in the second embodiment, specifically, at the time of discharge) of the secondary battery (that is, measures the OCV and obtains the OCV curve), calculates an inflection point in the measured voltage change, and calculates the degree of degradation of the secondary battery based on a difference between the calculated inflection point and a precalculated initial inflection point. Then, the correction unit 140 corrects the relation between the state of charge and the open circuit voltage based on the degree of degradation of the secondary battery calculated in the degradation degree detection and evaluation unit 130.

Here, as in the first embodiment, the difference is based on a relation between the inflection point in the measured voltage change (the differential curve of the OCV curve) and the precalculated initial inflection point. As described above, the inflection point in the measured voltage change (the differential curve of the OCV curve) corresponds to a peak (differential value peak) in differential values when the differential values of the voltage measured using the charge/discharge capacity of the secondary battery 60 or a measurement time as a variable are calculated. Specifically, the difference is a discharge capacity difference or a discharge time difference.

More specifically, the charge state estimation device 120 converts power supplied form the power source 50 into a voltage of a predetermined current and charges the secondary battery 60 configured by a lithium-ion secondary battery under constant-current and constant-voltage control. After the charge state estimation device 120 confirms that the power source 50 operates at every predetermined number of cycles or at intervals of a predetermined elapsed time, the charge state estimation device 120 controls the operation of the power source 50 under a charge termination condition recorded in the charge state estimation device 120 and fully charges the secondary battery 60. Subsequently, discharge of the secondary battery 60 is performed according to a discharge method based on the intermittent discharge, as described in the first embodiment.

More specifically, the current measurement circuit 37 measures a discharge current flowing in the secondary battery 60 and transmits the measurement result to the degradation degree detection and evaluation unit 130. The voltage measurement circuit 38 measures a voltage of the secondary battery 60 and transmits the measurement result to the degradation degree detection and evaluation unit 130. The temperature measurement circuit 39 measures a surface temperature of the secondary battery 60 and transmits the measurement result to the degradation degree detection and evaluation unit 130.

At the time of discharge of the secondary battery, the OCV measurement unit 31 calculates the OCV curve of the secondary battery 60 from data (that is, the measurement result of the voltage change between the positive and negative electrodes, in other words, the measurement result of the OCV) from the detection unit 36 according to an existing method and stores the OCV curve in the OCV measurement unit 31. Then, the differential calculation unit 32 calculates an inflection point of the differential curve of the OCV curve obtained by the OCV measurement unit 31 according to an existing method. That is, based on the OCV curve obtained by the OCV measurement unit 31, the differential calculation unit 32 calculates a differential curve (where the x axis represents the discharge capacity (Q) and the y axis represents dV/dQ) in which the discharge capacity is set as a variable or a differential curve (where the x axis represents a time (t) and the y axis represents dV/dt) at a discharge time (integrated value). Further, a differential value peak on the (dV/dQ) curve or the (dV/dt) curve is calculated according to an existing method, and the discharge capacity or the discharge time corresponding to the differential value peak is calculated. That is, the differential calculation unit 32 and the electrode potential determination unit 33 calculate the inflection point (which corresponds to the discharge capacity or the discharge time corresponding to the differential value peak and one or all of “A,” “B,” and “C” in FIG. 2A) in the measured voltage change and calculates a difference (specifically, a discharge capacity difference or a discharge time difference) between the calculated inflection point and a precalculated initial inflection point (which corresponds to a differential value peak on the initial negative electrode OCV curve and one or all of “A,” “B,” and “C” in FIG. 2C). Here, this difference corresponds to the degree of degradation of the secondary battery 60.

The difference corresponding to the degree of degradation of the secondary battery 60 is transmitted to the correction unit 140. The correction unit 140 compares the position of the calculated differential value peak (the value of a variable such as a charge/discharge capacity or the measurement time obtained at the differential value peak) to the inflection point (the charge/discharge capacity [discharge capacity (Q)] of the differential curve of the initial negative electrode OCV curve stored in the electrode potential determination unit 33 or the measurement time [discharge time (integrated value)]. Then, the correction unit 140 corrects the initial negative OCV curve based on this comparison result, calculates a shift amount of the OCV curve from a correction amount of the initial negative electrode OCV curve, and corrects the relation between the state of charge (SOC) and the open circuit voltage (OCV) based on the shift amount of the OCV curve. In this way, the corrected state of charge can be obtained. The corrected state of charge is displayed on the display unit 141.

The charge state estimation device 120 also sets a current voltage at the time of an operation in a constant-voltage region and a charge current at the time of an operation in a constant-current region. Further, the charge state estimation device 120 counts the number of cycles of charge and discharge performed from the start of use of the secondary battery 60 based on the data received from the current measurement circuit 37. Further, the charge state estimation device 120 measures an elapsed time from the start of use of the secondary battery 60.

Thus, in the second embodiment, the state of charge obtained as the result of the OCV measurement is corrected based on the evaluation result of the degree of degradation of the secondary battery, specifically, the discharge capacity difference or the discharge time difference. Thus, even in the second embodiment, the degree of degradation of the secondary battery can be determined quantitatively under an actual use environment and the appropriate state of charge can be displayed, thereby obtaining the state of charge with high accuracy.

### Third Embodiment

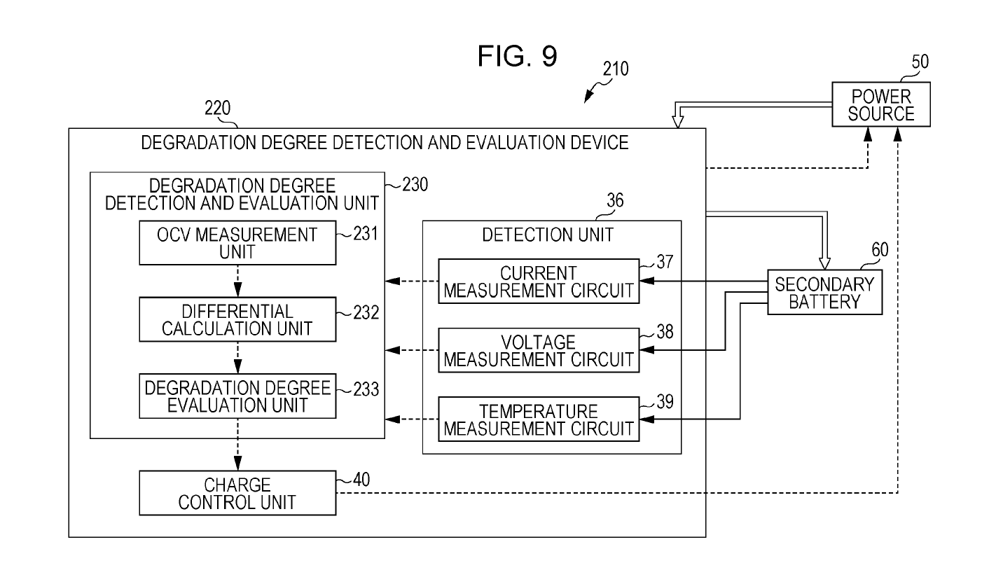

A third embodiment of the present disclosure relates a degradation degree estimation device for a secondary battery of a first form, a secondary battery device of a third form, and a degradation degree estimation method for a secondary battery of a first form. FIG. 9 is a block diagram illustrating the degradation degree estimation device for a secondary battery and a secondary battery device according to the third embodiment.

Secondary battery devices 210 and 310 according to the third embodiment and the fourth embodiment to be described below are secondary battery devices that include a secondary battery (secondary battery cell) 60 including positive and negative electrodes and degradation degree estimation devices 220 and 320 for the secondary battery 60, respectively. The degradation degree estimation devices 220 and 320 according to the third embodiment and the fourth embodiment to be described below or the degradation degree estimation devices 220 and 320 of the secondary battery devices 210 and 310 according to the third embodiment and the fourth embodiment to be described below include degradation degree detection and evaluation units 230 and 330 that detect and evaluate the degree of degradation of the secondary battery 60, respectively.

The degradation degree detection and evaluation units 230 and 330 include OCV measurement units 231 and 331, differential calculation units 232 and 332, and degradation degree evaluation units 233 and 333, respectively. The degradation degree estimation devices 220 and 320 each further include a detection unit 36. The detection unit 36 includes a current measurement circuit 37, a voltage measurement circuit 38, and a temperature measurement circuit 39. The degradation degree detection and evaluation units 230 and 330 themselves can be configured by existing circuits. Even in the third embodiment, the negative electrode of the secondary battery 60 is formed of graphite and the positive electrode thereof is formed of lithium iron phosphate, as in the first embodiment.

Even in the third embodiment, an initial positive electrode OCV curve and an initial negative electrode OCV curve are calculated, as in the first embodiment. As in the first embodiment, a charge/discharge capacity [discharge capacity (Q)] at the inflection points obtained from the precalculated initial positive electrode OCV curve and the precalculated initial negative electrode OCV curve, and further, the differential curves of the initial positive electrode OCV curve and/or the initial negative electrode OCV curve is stored in the degradation degree evaluation unit 233. The inflection points correspond to differential value peaks on these curves.

Therefore, in the third embodiment, the degradation degree detection and evaluation unit 230 measures (measures the OCV and obtains the OCV curve) a voltage change between the positive and negative electrodes at the time of the charge or the discharge (in the third embodiment, specifically, at the time of the discharge) of the secondary battery 60 and calculates an inflection point in the measured voltage change and the voltage value at the inflection point. The degree of degradation of the secondary battery 60 is calculated based on a difference between the inflection point and a precalculated initial inflection point and a difference between the voltage value at the inflection point and an initial voltage value at the precalculated initial inflection point.

Here, the inflection point in the measured voltage change corresponds to a peak in differential values when the differential value (dV/dQ) of the voltage (V) measured using the charge/discharge capacity [discharge capacity (Q)] of the secondary battery as a variable are calculated. Specifically, the position of a peak in a differential value corresponding to the inflection point in the measured voltage change is a value of the discharge capacity of the secondary battery for which a full charge state of the secondary battery is a start time point. The degree of degradation of the secondary battery is expressed by, for example, a change from an initial capacity calculated from an initial potential change (initial OCV curve).

As in the first embodiment, the difference is based on a relation between the inflection point in the measured voltage change (the differential curve of the OCV curve) and the precalculated initial inflection point. As described above, the inflection point in the measured voltage change (the differential curve of the OCV curve) corresponds to a peak (differential value peak) in differential values when the differential values of the voltage measured using the charge/discharge capacity [discharge capacity(Q)] of the secondary battery 60 as a variable are calculated. Specifically, the difference is a discharge capacity difference.

Specifically, the degradation degree estimation device 220 also functioning as a charge control device converts power supplied form the power source 50 into a voltage of a predetermined current and charges the secondary battery 60 configured by a lithium-ion secondary battery under constant-current and constant-voltage control. After the degradation degree estimation device 220 confirms that the power source 50 operates at every predetermined number of cycles or at intervals of a predetermined elapsed time, the degradation degree estimation device 220 controls the operation of the power source 50 under a charge termination condition recorded in the degradation degree estimation device 220 and fully charges the secondary battery 60.

Subsequently, discharge of the secondary battery 60 is performed according to a discharge method based on the same intermittent discharge as that described in the first embodiment. As in the first embodiment, alternatively, the intermittent discharge may be performed only before and after a differential value peak in a (dV/dQ) curve, or low-rate discharge may be performed. Thus, as in the first embodiment, the OCV measurement unit 231 can calculate a part of the open circuit voltage (open terminal voltage OCV) curve. Further, as in the first embodiment, based on the part of the open circuit voltage (OCV curve) curve calculated by the OCV measurement unit 231, the differential calculation unit 232 calculates a differential curve (where the x axis represents the discharge capacity (Q) and the y axis represents dV/dQ) in which the discharge capacity is set as a variable. Even in the third embodiment, three differential value peaks (A, B, and C) are present on the finally obtained (dV/dQ) curve a₂, as in the first embodiment. That is, during a stable discharge period before the over-discharge state, the three differential value peaks (A, B, and C) are present on the (dV/dQ) curve a₂. In the third embodiment, however, the initial differential value peak (A) is used to evaluate the degree of degradation.

The current measurement circuit 37 measures a discharge current flowing in the secondary battery 60 and transmits the measurement result to the degradation degree detection and evaluation unit 230. The voltage measurement circuit 38 measures a voltage of the secondary battery 60 and transmits the measurement result to the degradation degree detection and evaluation unit 230. The temperature measurement circuit 39 measures a surface temperature of the secondary battery 60 and transmits the measurement result to the degradation degree detection and evaluation unit 230.

More specifically, at the time of the discharge of the secondary battery, the OCV measurement unit 231 calculates the OCV curve of the secondary battery 60 up to acquisition of data according to an existing method based on the data (that is, the measurement result of the voltage change between the positive and negative electrodes, in other words, the measurement result of the OCV) from the detection unit 36 and stores the OCV curve in the OCV measurement unit 231. The OCV curve of the secondary battery 60 obtained by acquiring the data in the detection unit 36 at intervals of a given time (for example, intervals of 10 seconds) is gradually lengthened.

Normally, when the charge ends and the discharge of the secondary battery 60 starts, as described above, the differential value of the OCV curve first decreases, is subsequently changed to increase. When the differential value takes the maximum value, the differential value is changed to decrease again. The differential calculation unit 232 calculates an inflection point of the differential curve of the OCV curve according to an existing method based on the measurement value of the OCV obtained by the OCV measurement unit 231. That is, based on the differential value (dV/dQ) of the OCV before and after the maximum value of the differential curve of the OCV curve, the differential calculation unit 232 can calculate the value of (dV/dQ) at the inflection point based on, for example, a 3-point centered difference scheme or a 5-point centered difference scheme. This value is referred to as (dV/dQ)_{deg} for convenience. When (dV/dQ)_{deg} can be obtained, the value of Q is referred to as Q_{peak-deg}. In the first and second embodiments and even in a fourth embodiment to be described below, the value of (dV/dQ) at the inflection point can be calculated likewise based on the 3-point centered difference scheme or the 5-point centered difference scheme.

The initial voltage value at the initial inflection point refers to a value of (dV/dQ) at the initial differential value peak (A) on the above-described (dV/dQ) curve a₂. This value is referred to as (dV/dQ)₁ₛₜ for convenience. When (dV/dQ)₁ₛₜ can be obtained, the value of Q is referred to as Qₚₑₐₖ₋₁ₛₜ.

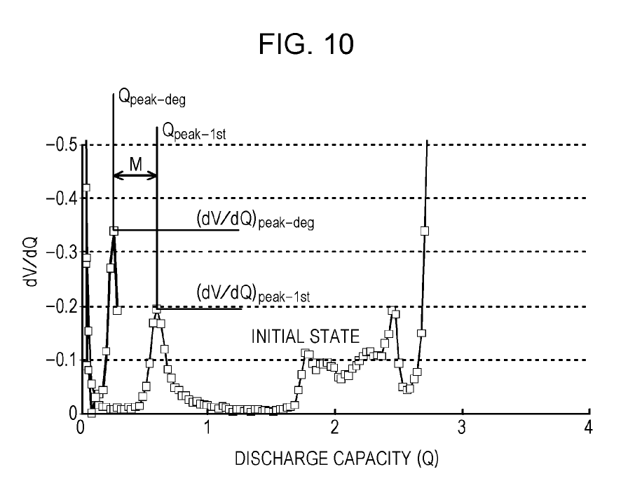

Here, a difference S between a voltage value at an inflection point and a precalculated initial voltage value at the initial inflection point can be calculated as follows. Further, “k” is a coefficient that considers a voltage drop. A difference M between the inflection point and the precalculated initial inflection point can be calculated as follows (see FIG. 10).

S=k×[(dV/dQ)₁ₛₜ]/[(dV/dQ)_{deg}]

M=Qₚₑₐₖ₋₁ₛₜ−Q_{peak-deg}

Here, a relation between a value of (S, M) and a change amount (for example, a percentage on the assumption that the initial capacity calculated from the initial OCV curve is 100%) from the initial OCV curve is stored as table in the degradation degree evaluation unit 233. This table can be obtained by carrying out an experiment under various conditions in a plurality of secondary batteries. By calculating a percentage on the assumption that the initial capacity calculated from the initial OCV curve from the table is 100% based on the value (S, M) obtained from the expressions above, it is possible to calculate the degree of degradation indicating a capacity expected value corresponds to how many % of the initial capacity calculated from the initial OCV curve.

Further, a relation between the value of (S, M) and an increase amount of the negative electrode potential described in the first embodiment is stored as a table in the degradation degree evaluation unit 233. This table can be obtained in advance by carrying out an experiment under various conditions in a plurality of secondary batteries. By calculating the increase amount of the negative electrode potential in the table based on the value (S, M) obtained from the expressions above, it is possible to calculate the negative electrode potential at the time of full charge, as in the first embodiment. Here, the increase amount of the negative electrode potential calculated in this way corresponds to the degree of degradation of the secondary battery 60. As in the first embodiment, data regarding the increase amount of the negative electrode potential corresponding to the degree of degradation of the secondary battery 60 is transmitted to the charge control unit 40. The charge control unit 40 sets (determines) the positive electrode potential (or a full-charge voltage) in consideration of the increase amount of the negative electrode potential (the negative electrode potential at the time of full charge) so that the potential (or the full-charge voltage) of the positive electrode to be applied at the time of the charge of the secondary battery 60 does not increase. That is, the secondary battery 60 is charged using, as the full-charge voltage, a voltage obtained by reducing the increase amount of the negative electrode potential from an initial full-charge voltage at the start time of use of the secondary battery. Further, the potential (or the full-charge voltage) of the positive electrode may be set (determined) in consideration of the surface temperature of the secondary battery received from the temperature measurement circuit 39.

As described in the second embodiment, the degradation degree evaluation unit 233 likewise compares the value of (S, M) to the inflection point (the charge/discharge capacity [discharge capacity (Q)]) of the differential curve of the initial negative electrode OCV curve stored in the degradation degree evaluation unit 233. Then, the degradation degree evaluation unit 233 corrects the initial negative OCV curve based on this comparison result, calculates a shift amount of the OCV curve from a correction amount of the initial negative electrode OCV curve, and corrects the relation between the state of charge (SOC) and the open circuit voltage (OCV) based on the shift amount of the OCV curve. In this way, the corrected state of charge can be obtained. The corrected state of charge is displayed on a display unit (not illustrated).

The degradation degree estimation device 220 also sets a charge current at the time of an operation in a constant-voltage region and a charge current at the time of an operation in a constant-current region. Further, the degradation degree estimation device 220 counts the number of cycles of charge and discharge from the start of use of the secondary battery 60 based on the data received from the current measurement circuit 37. Further, the degradation degree estimation device 220 measures an elapsed time from the start of use of the secondary battery 60. The same applies also to the fourth embodiment to be described below.

In the third embodiment, as described above, the degree of degradation of the secondary battery can be determined quantitatively under an actual use environment, and thus, for example, the voltage expected value of the full charge can be calculated, the positive electrode potential at the time of the full charge can normally remain constant, and the corrected state of charge can be obtained. Further, since the degree of degradation of the secondary battery can be quantitatively determined by calculating the value of (dV/dQ) at one inflection point, the degree of degradation of the secondary battery can be estimated under an actual use environment with high efficiency and for a short time.

### Fourth Embodiment

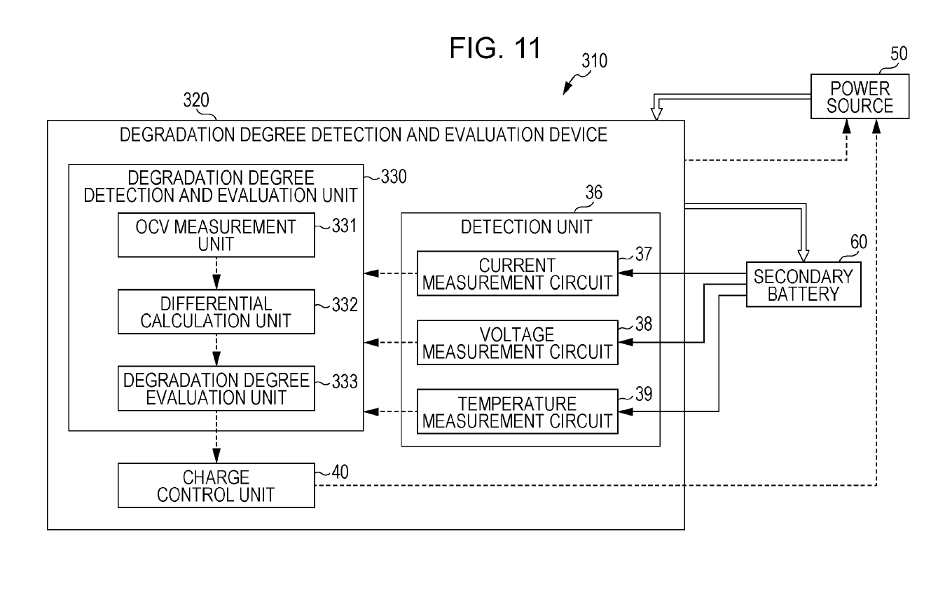

The fourth embodiment of the present of the present disclosure relates a degradation degree estimation device for a secondary battery of a second form, a secondary battery device of a fourth form, and a degradation degree estimation method for a secondary battery of a second form. FIG. 11 is a block diagram illustrating the degradation degree estimation device for a secondary battery and a secondary battery device according to the fourth embodiment.

In the fourth embodiment, the degradation degree detection and evaluation unit 330 measures a voltage change between the positive and negative electrode at the time of charge or discharge of the secondary battery 60, calculates an inflection point in the measured voltage change and a voltage value at the inflection point, and calculates the degree of degradation of the secondary battery based on the voltage value at the inflection point and stored charge/discharge history data of the second battery. Here, the inflection point in the measured voltage change corresponds to a peak in differential values (dV/dQ) when the differential values of the voltage (V) measured using the charge/discharge capacity [discharge capacity(Q)] of the secondary battery as a variable are calculated. The state of charge of the secondary battery 60 can be calculated based on, for example, a current integration method. The degree of degradation of the secondary battery is expressed by, for example, a change from an initial capacity calculated from the initial OCV curve.

The charge/discharge history data of the secondary battery 60 stored in the degradation degree evaluation unit 333 of the degradation degree detection and evaluation unit 330 includes at least a discharge rate (current rate), a temperature of the secondary battery, and a state of charge (SOC). More specifically, the charge/discharge history data shown in Table 1 below is stored in the degradation degree detection and evaluation unit 330. In Table 1, “time rate” is a value indicating how many % of a time in which the secondary battery 60 is put under a given discharge rate (current rate), a given temperature of the secondary battery, a given state of charge (SOC) occupies the entire discharge/charge time of the secondary battery 60. In Table 1, “state of charge” means that, for example, an average value of the state of charge at start of the update and end of the update is calculated by a current integration method or the like. Further, in certain charge/discharge history data, for example, a relation showing a certain degree of degradation (specifically, a change amount from an initial capacity calculated from the initial potential change (initial OCV curve)) is obtained in advance by carrying out an experiment under various conditions in a plurality of secondary batteries, and then is stored as a “reference charge/discharge history table” in the degradation degree evaluation unit 333. Each table of the reference charge/discharge history table specifically has the same data structure as that of the charge/discharge history data shown in Table 1. Each table can be associated with the degree of degradation (specifically, for example, the change amount from the initial capacity calculated from the initial OCV curve). Table 1 is merely an example and the embodiment of the present disclosure is not limited to the table shown in Table 1.

TABLE 1

| DISCHARGE RATE | 0 | | | | . . . |
|---|---|---|---|---|---|
| TEMPERATURE OF | 0 to 25 | 25 to | 45 to | . . . | |
| SECONDARY BATTERY | | 45 | 60 | | |

| | | | | |
|---|---|---|---|---|
| STATE OF CHARGE | 0 to | 10 to | . . . | . . . |
| | 10 | 20 | | |
| TIME RATE | 10 | 15 | . . . | |

Even in the fourth embodiment, the degradation degree estimation device 320 also functioning as a charge control device converts power supplied form the power source 50 into a voltage of a predetermined current and charges the secondary battery 60 configured by a lithium-ion secondary battery under constant-current and constant-voltage control. After the degradation degree estimation device 320 confirms that the power source 50 operates at every predetermined number of cycles or at intervals of a predetermined elapsed time, the degradation degree estimation device 320 controls the operation of the power source 50 under a charge termination condition recorded in the degradation degree estimation device 320 and fully charges the secondary battery 60.

Subsequently, discharge of the secondary battery 60 is performed according to a discharge method based on the same intermittent discharge as that described in the first embodiment. The intermittent discharge may be performed only before and after the initially emerging differential value peak (A) on the (dV/dQ) curve, or low-rate discharge may be performed. Thus, as in the first embodiment, the OCV measurement unit 331 can calculate a part of the open circuit voltage (open terminal voltage OCV) curve. Further, as in the first embodiment, based on the part of the open circuit voltage (OCV curve) curve calculated by the OCV measurement unit 331, the differential calculation unit 332 calculates a differential curve (where the x axis represents the discharge capacity (Q) and the y axis represents dV/dQ) in which the discharge capacity is set as a variable. Even in the fourth embodiment, as described above, the initial differential value peak (A) is used to evaluate the degree of degradation, as in the third embodiment.

The current measurement circuit 37 measures a discharge current flowing in the secondary battery 60 and transmits the measurement result to the degradation degree detection and evaluation unit 330. Based on this result, the OCV measurement unit 331 calculates the state of charge (SOC) of the secondary battery 60 according to, for example, a current integration method. The voltage measurement circuit 38 measures a voltage of the secondary battery 60 and transmits the measurement result to the degradation degree detection and evaluation unit 330. The temperature measurement circuit 39 measures a surface temperature of the secondary battery 60 and transmits the measurement result to the degradation degree detection and evaluation unit 330.

More specifically, at the time of the discharge of the secondary battery, the OCV measurement unit 331 calculates the OCV of the secondary battery 60 according to an existing method based on the data (that is, the measurement result of the voltage change between the positive and negative electrodes, in other words, the measurement result of the OCV) from the detection unit 36. The differential calculation unit 332 calculates an inflection point of the differential curve of the OCV curve according to an existing method based on the measurement value of the OCV obtained by the OCV measurement unit 331. That is, based on the differential value (dV/dQ) of the OCV before and after the maximum value of the differential curve of the OCV curve, the differential calculation unit 332 can calculate a value of (dV/dQ)_{deg} at the inflection point.

The degradation degree evaluation unit 333 updates the charge/discharge history data based on a discharge rate measurement value of the secondary battery 60, a temperature measurement value of the secondary battery 60, and a measurement value of the state of charge (SOC), and the degradation degree evaluation unit 333 stores the charge/discharge history data. The degradation degree evaluation unit 333 examines the updated charge/discharge history data is identical with which table of the reference charge/discharge history table. Specifically, the degradation degree evaluation unit 333 derives a function of (dV/dQ)_{deg} and the degree of degradation from the reference charge/discharge history table based on a distribution of the charge/discharge rates of the updated charge/discharge history data, a distribution of the temperature measurement values, and a distribution of the states of charge. Then, the degree of degradation is calculated by substituting the measurement value of (dV/dQ)_{deg} into the obtained function. Then, the degree of degradation (specifically, for example, the change amount from the initial capacity calculated from the initial OCV curve) associated with the identical table of the reference charge/discharge history table is calculated. That is, by calculating the percentage on the assumption that the initial capacity calculated from the initial OCV curve is 100%, it is possible to calculate the degree of degradation indicating a capacity expected value corresponds to how many % of the initial capacity calculated from the initial OCV curve.

Further, the degradation degree evaluation unit 333 can associate each table of the reference charge/discharge history table with an increase amount of the negative electrode potential described in the first embodiment. This association can be obtained in advance by carrying out an experiment under various conditions in a plurality of secondary batteries. Then, the degradation degree evaluation unit 333 examines the updated charge/discharge history data is identical with which table of the reference charge/discharge history table, obtains the increase amount of the negative electrode potential which is the degree of degradation associated with the identical table of the reference charge/discharge history table, and thus can calculate the negative electrode potential at the time of the full charge, as in the first embodiment. Here, the increase amount of the negative electrode potential calculated in this way corresponds to the degree of the degradation of the secondary battery 60. As in the first embodiment, data regarding the increase amount of the negative electrode potential corresponding to the degree of degradation of the secondary battery 60 is transmitted to the charge control unit 40. The charge control unit 40 sets (determines) the positive electrode potential (or a full-charge voltage) in consideration of the increase amount (the negative electrode potential at the time of full charge) so that the potential (or the full-charge voltage) of the positive electrode to be applied at the time of the charge of the secondary battery 60 does not increase. That is, the secondary battery 60 is charged using, as the full-charge voltage, a voltage obtained by reducing the increase amount of the negative electrode potential from an initial full-charge voltage at the start time of use of the secondary battery. Further, the potential (or the full-charge voltage) of the positive electrode may be set (determined) in consideration of the surface temperature of the secondary battery received from the temperature measurement circuit 39.

As described in the second embodiment, the degradation degree evaluation unit 333 can likewise associate each table of the reference charge/discharge history table with a shift amount of the OCV curve from the correction amount of the initial negative electrode OCV curve. Further, a shift amount of the OCV curve from the correction amount of the initial negative electrode OCV curve is stored in the degradation degree evaluation unit 333. Then, the degradation degree evaluation unit 333 can examine the updated charge/discharge history data is identical with which table of the reference charge/discharge history table and obtain the shift amount of the OCV curve which is the degree of degradation associated with the identical table of the reference charge/discharge history table. Further, the degradation degree evaluation unit 333 corrects the relation between the state of charge (SOC) and the open circuit voltage (OCV) based on the shift amount of the OCV curve. In this way, the corrected state of charge can be obtained. The corrected state of charge is displayed on a display unit (not illustrated).

Even in the fourth embodiment, as described above, the degree of degradation of the secondary battery can be determined quantitatively under an actual use environment, and thus, for example, the voltage expected value of the full charge can be obtained, the positive electrode potential at the time of the full charge can normally remain constant, and the corrected state of charge can be obtained. Further, since the degree of degradation of the secondary battery can be quantitatively determined by calculating the value of (dV/dQ) at one inflection point, the degree of degradation of the secondary battery can be estimated under an actual use environment with high efficiency and for a shorter time, compared to the third embodiment.

The preferred embodiments of the present disclosure have hitherto been described, but embodiments of the present disclosure are not limited to these embodiments. The configurations and structures of the secondary battery, the secondary battery device, the charge control device including the degradation degree detection and evaluation unit and the charge control unit, the charge state estimation device including the degradation degree detection and evaluation unit and the correction unit, and the degradation degree estimation device including the degradation degree detection and evaluation unit according to the embodiments are merely examples and can appropriately be modified. The charge control device for a secondary battery described in the first embodiment may be combined with the charge state estimation device for the secondary battery described in the second embodiment. Further, the charge control method for the secondary battery described in the first embodiment may be combined with the charge state estimation method for the secondary battery described in the second embodiment. The first, second, third, and fourth embodiments may be combined arbitrarily. In the embodiments, the various processes and the charge control of the secondary battery only in the discharge state have been described, but the processes and charge control may be applied also to a charge state. In the embodiments, only the description has been made based on the potential change (the inflection point in the potential change of the negative electrode) of the negative electrode. However, even in regard to the positive electrode, the same process as the process performed based on the potential change of the negative electrode (the inflection point in the potential change of the negative electrode) may be performed based on a potential change (an inflection point in a potential change of the negative electrode) of the positive electrode in the secondary battery in which the same potential change is made. In the embodiments, the charge of the secondary battery has been controlled only based on the CC-CV method, but embodiments of the present disclosure are not limited thereto. Even when a voltage is maintained with the charge voltage, embodiments of the present disclosure can be applied.

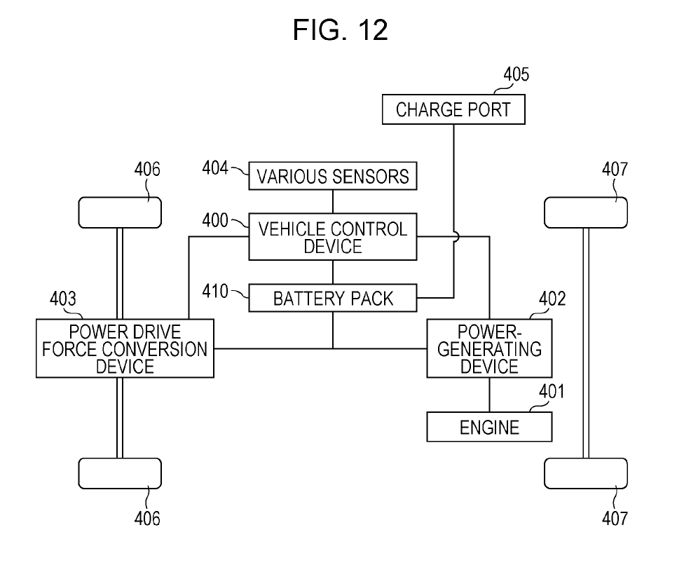

The charge control devices for the secondary battery, the charge control methods for the secondary battery, the charge state estimation devices for the secondary battery, the charge state estimation methods for the secondary battery, the degradation degree estimation devices for the secondary battery, the degradation degree estimation methods for the secondary battery, and the secondary battery devices described above in the embodiments of the present disclosure can be applied to, for example, an electric vehicle. Here, examples of the electric vehicle include an electric automobile, an electric motorbike, an electric assist bicycle, a golf cart, an electric cart, and a Segway (registered trademark). In this case, a battery pack (assembled battery) in which a plurality of secondary batteries are connected in series or in parallel may be used. For example, when the electric vehicle is applied to an electric automobile, the electric vehicle includes, as the configuration a hybrid vehicle is illustrated in FIG. 12: a battery pack 410 that includes the secondary batteries 60 according to the first to fourth embodiments; and a power drive force conversion device 403. The battery pack 410 is connected to a power-generating device 402 that is configured to charge the battery pack 410. The power drive force conversion device 403 is connected to the downstream side of the battery pack 410.

The charge control methods for the secondary battery, the charge state estimation methods for the secondary battery, and the degradation degree estimation methods for the secondary battery described in the first to fourth embodiments are similarly performed.

The electric automobile is an automobile that uses power generated in a power-generating device 402 driven by an engine 401 or temporarily accumulates the power in the battery pack 410 and uses the power from the battery pack 410 and which is driven by a power drive force conversion device 403. The electric vehicle further includes, for example, a vehicle control device 400, various sensors 404, a charging port 405, drive wheels 406, and vehicle wheels 407. The vehicle control device 400 includes the charge control device 20 for the secondary battery, the charge state estimation device 120 for the secondary battery and/or the degradation degree estimation device 220 or 320 for the secondary battery described in the first to fourth embodiments.

The electric vehicle according to the second embodiment drives using the power drive force conversion device 403 as a power source. The power drive force conversion device 403 includes, for example, a driving motor. For example, the power drive force conversion device 403 is operated by the power of the battery pack 410 and a rotating force of the power drive force conversion device 403 is transferred to the drive wheels 406. Any one of an alternating-current motor and a direct-current motor can be applied as the power drive force conversion device 403. The various sensors 404 control the number of rotations of the engine through the vehicle control device 400 or control the degree of openness (the degree of throttle openness) of a throttle valve (not illustrated). The various sensors 404 include a speed sensor, an acceleration sensor, and an engine rotation number sensor. The rotating force of the engine 401 can be transferred to the power-generating device 402, and thus the power generated by the rotating force in the power-generating device 402 is accumulated in the battery pack 410.

When the electric vehicle is decelerated by a braking mechanism (not illustrated), a resistance force at the time of the deceleration is added as a rotating force to the power drive force conversion device 403 and regenerative power generated by the rotating force in the power drive force conversion device 403 is accumulated in the battery pack 410. Further, the battery pack 410 can receive the power from an outside power source using the charging port 405 as an input port and accumulate the power. Alternatively, the power accumulated in the battery pack 410 can be supplied to the outside using the charging port 405 as an output port.

Although not illustrated, an information processing device performs information processing relevant to vehicle control based on information from the battery pack 410 is provided.

A series hybrid vehicle that drives by the power drive force conversion device 403 using the power generated by the power-generating device 402 driven by the engine 401 and the power temporarily accumulated in the battery pack 410 has been described. However, a parallel hybrid vehicle may be configured which appropriately switches and uses the three systems in which the vehicle drives only by the engine 401, drives only by the power drive force conversion device 403, and drives by both the engine 401 and the power drive force conversion device 403 using any one of the outputs of the engine 401 and the power drive force conversion device 403 as a driving source. Further, a vehicle may be configured which drives only by a driving motor without using an engine.

Embodiments of the present disclosure can be configured as follows.

[1] Charge Control Device for Secondary Battery

A charge control device for a secondary battery controls a charge of the secondary battery including positive and negative electrodes. The charge control device includes: a degradation degree detection and evaluation unit that detects and evaluates a degree of degradation of the secondary battery; and a charge control unit. The charge control unit controls a voltage application state to the electrode at a time of charge of the secondary battery based on an evaluation result of the degree of degradation of the second battery in the degradation degree detection and evaluation unit.

[2] In the charge control device for a secondary battery described in [1], the charge control unit may control a voltage application state to the positive electrode at a time of full charge of the secondary battery based on the evaluation result of the degree of degradation of the second battery in the degradation degree detection and evaluation unit.

[3] In the charge control device for a secondary battery described in [2], the charge control unit may set a potential of the positive electrode at the time of full charge of the secondary battery based on the evaluation result of the degree of degradation of the second battery in the degradation degree detection and evaluation unit.

[4] In the charge control device for a secondary battery described in [3], the degradation degree detection and evaluation unit may measure a voltage change between the positive and negative electrodes at a time of charge or discharge of the secondary battery, calculate an inflection point in the measured voltage change, and calculate the degree of degradation of the secondary battery based on a difference between the inflection point and a precalculated initial inflection point. The charge control unit may set a potential of the positive electrode to be applied at the time of charge of the secondary battery based on the degree of degradation of the second battery calculated by the degradation degree detection and evaluation unit.

[5] In the charge control device for a secondary battery described in [4], the difference may be based on a relation between the inflection point in the measured voltage change and the precalculated initial inflection point.

[6] In the charge control device for a secondary battery described in [4] or [5], the inflection point in the measured voltage change may correspond to a peak in differential values when the differential values of a voltage measured by setting a charge/discharge capacity of the secondary battery or a measurement time as a variable are calculated.

[7] In the charge control device for a secondary battery described in any one of [1] to [6], the charge control unit may control a voltage to be applied to the positive electrode at the time of charge of the secondary battery based on the evaluation result of the degree of degradation of the second battery in the degradation degree detection and evaluation unit.

[8] In the charge control device for a secondary battery described in any one of [1] to [7], the negative electrode may be formed of a material in which an inflection point is present in a potential change at the time of charge or discharge of the secondary battery and the positive electrode may be formed of a material in which no inflection point is present in the potential change.

[9] In the charge control device for a secondary battery described in [8], the secondary battery may include a lithium-ion secondary battery. The negative electrode may be formed of graphite. The positive electrode may be formed of lithium iron phosphate.

[10] Secondary Battery Device: First Form

A secondary battery device includes: a secondary battery that includes positive and negative electrodes; and a charge control device that controls a charge of the secondary battery. The charge control device includes a degradation degree detection and evaluation unit that detects and evaluates a degree of degradation of the secondary battery, and a charge control unit. The charge control unit controls a voltage application state to the electrode at a time of charge of the secondary battery based on an evaluation result of the degree of degradation of the second battery in the degradation degree detection and evaluation unit.

[11] Charge Control Method for Secondary Battery

A charge control method for a secondary battery of controlling charge of the secondary battery including positive and negative electrodes includes: detecting and evaluating a degree of degradation of the secondary battery; and controlling a voltage application state to the electrode at a time of full charge of the secondary battery based on an evaluation result of the degree of degradation of the secondary battery.

[12] Charge State Estimation Device for Secondary Battery

A charge state estimation device for a secondary battery including positive and negative electrodes includes: a degradation degree detection and evaluation unit that detects and evaluates a degree of degradation of the secondary battery; and a correction unit that corrects a relation between a state of charge and an open circuit voltage. The correction unit corrects the relation between the state of charge and the open circuit voltage based on an evaluation result of the degree of degradation of the second battery in the degradation degree detection and evaluation unit.

[13] In the charge state estimation device for a secondary battery described in [12], the correction unit may correct the relation between the state of charge and the open circuit voltage based on the evaluation result of the degree of degradation of the second battery in the degradation degree detection and evaluation unit.

[14] In the charge state estimation device for a secondary battery described in [13], the degradation degree detection and evaluation unit may measure a voltage change between the positive and negative electrodes at a time of charge or discharge of the secondary battery, calculate an inflection point in the measured voltage change, and calculate the degree of degradation of the secondary battery based on a difference between the inflection point and a precalculated initial inflection point. The correction unit corrects the relation between the state of charge and the open circuit voltage based on the degree of degradation of the second battery calculated by the degradation degree detection and evaluation unit.

[15] In the charge state estimation device for a secondary battery described in [14], the difference may be based on a relation between the inflection point in the measured voltage change and the precalculated initial inflection point.

[16] In the charge state estimation device for a secondary battery described in [14] or [15], the inflection point in the measured voltage change may correspond to a peak in differential values when the differential values of a voltage measured by setting a charge/discharge capacity of the secondary battery or a measurement time as a variable are calculated.

[17] In the charge state estimation device for a secondary battery described in any one of [12] to [16], the negative electrode may be formed of a material in which an inflection point is present in a potential change at the time of charge or discharge of the secondary battery and the positive electrode may be formed of a material in which no inflection point is present in the potential change.

[18] In the charge state estimation device for a secondary battery described in [17], the secondary battery may include a lithium-ion secondary battery. The negative electrode may be formed of graphite. The positive electrode may be formed of lithium iron phosphate.

[19] Secondary Battery Device: Second Form

A secondary battery device includes: a secondary battery that includes positive and negative electrodes; and a charge state estimation device for a secondary battery. The charge state estimation device includes a degradation degree detection and evaluation unit that detects and evaluates a degree of degradation of the secondary battery, and a correction unit that corrects a relation between a state of charge and an open circuit voltage. The correction unit corrects the relation between the state of charge and the open circuit voltage based on an evaluation result of the degree of degradation of the second battery in the degradation degree detection and evaluation unit.

[20] Charge State Estimation Method for Secondary Battery

A charge state estimation method for a secondary battery of estimating a charge state of the secondary battery including positive and negative electrodes includes: detecting and evaluating a degree of degradation of the secondary battery; and correcting a relation between a state of charge and an open circuit voltage based on an evaluation result of the degree of degradation of the secondary battery.

[21] Degradation Degree Estimation Device for Secondary Battery First Form

A degradation degree estimation device for a secondary battery including positive and negative electrodes includes a degradation degree detection and evaluation unit that detects and evaluates a degree of degradation of the secondary battery. The degradation degree detection and evaluation unit may measure a voltage change between the positive and negative electrodes at a time of charge or discharge of the secondary battery, calculate an inflection point in the measured voltage change and a voltage value at the inflection point, and calculate the degree of degradation of the secondary battery based on a difference between the inflection point and a precalculated initial inflection point and a difference between the voltage value at the inflection point and an initial voltage value at the precalculated initial inflection point.

[22] In the degradation degree estimation device for a secondary battery described in [21], the inflection point in the measured voltage change may correspond to a peak in differential values when the differential values of a voltage measured by setting a charge/discharge capacity of the secondary battery as a variable are calculated.

[23] In the degradation degree estimation device for a secondary battery described in [22], a position of the peak of the differential value corresponding to the inflection point in the measured voltage change may be a value of a discharge capacity of the secondary battery for which a full charge state of the secondary battery is a start time point.

[24] In the degradation degree estimation device for a secondary battery described in any one of [21] to [23], the degree of degradation of the secondary battery may be expressed by a change from an initial capacity calculated from an initial potential change.

[25] Degradation Degree Estimation Device for Secondary Battery Second Form

A degradation degree estimation device for a secondary battery including positive and negative electrodes includes a degradation degree detection and evaluation unit that detects and evaluates a degree of degradation of the secondary battery. The degradation degree detection and evaluation unit may measure a voltage change between the positive and negative electrodes at a time of charge or discharge of the secondary battery, calculate an inflection point in the measured voltage change and a voltage value at the inflection point, and calculate the degree of degradation of the secondary battery based on a voltage value at the inflection point and stored charge/discharge history data of the secondary battery.

[26] In the degradation degree estimation device for a secondary battery described in [25], the charge/discharge history data may include at least a discharge rate, a temperature of the secondary battery, and a state of charge.

[27] In the degradation degree estimation device for a secondary battery described in [25] or [26], the degree of degradation of the secondary battery may be expressed by a change from an initial capacity calculated from an initial potential change.

[28] In the degradation degree estimation device for a secondary battery described in any one of [21] to [27], the negative electrode may be formed of a material in which an inflection point is present in a potential change at the time of charge or discharge of the secondary battery and the positive electrode may be formed of a material in which no inflection point is present in the potential change.

[29] In the degradation degree estimation device for a secondary battery described in [28], the secondary battery may include a lithium-ion secondary battery. The negative electrode may be formed of graphite. The positive electrode may be formed of lithium iron phosphate.

[30] Secondary Battery Device: Third Form

A secondary battery device includes: a secondary battery that includes positive and negative electrodes; and a degradation degree estimation device for the secondary battery. The degradation degree estimation device may include a degradation degree detection and evaluation unit that detects and evaluates a degree of degradation of the secondary battery. The degradation degree detection and evaluation unit may measure a voltage change between the positive and negative electrodes at a time of charge or discharge of the secondary battery, calculate an inflection point in the measured voltage change and a voltage value at the inflection point, and calculate the degree of degradation of the secondary battery based on a difference between the inflection point and a precalculated initial inflection point and a difference between the voltage value at the inflection point and an initial voltage value at the precalculated initial inflection point.

[31] Degradation Degree Estimation Method for Secondary Battery First Form

A degradation degree estimation method for a secondary battery of estimating a charge state of the secondary battery including positive and negative electrodes includes: measuring a voltage change between the positive and negative electrodes at a time of charge or discharge of the secondary battery and calculating an inflection point in the measured voltage change and a voltage value at the inflection point; and calculating the degree of degradation of the secondary battery based on a difference between the inflection point and a precalculated initial inflection point and a difference between the voltage value at the inflection point and an initial voltage value at the precalculated initial inflection point.

[32] Secondary Battery Device: Fourth Form

A secondary battery device includes: a secondary battery that includes positive and negative electrodes; and a degradation degree estimation device for the secondary battery. The degradation degree estimation device may include a degradation degree detection and evaluation unit that detects and evaluates a degree of degradation of the secondary battery. The degradation degree detection and evaluation unit may measure a voltage change between the positive and negative electrodes at a time of charge or discharge of the secondary battery, calculate an inflection point in the measured voltage change and a voltage value at the inflection point, and calculate the degree of degradation of the secondary battery based on a voltage value at the inflection point and stored charge/discharge history data of the secondary battery.

[33] Degradation Degree Estimation Method for Secondary Battery Second Form

A degradation degree estimation method for a secondary battery of estimating a charge state of the secondary battery including positive and negative electrodes includes: measuring a voltage change between the positive and negative electrodes at a time of charge or discharge of the secondary battery and calculating an inflection point in the measured voltage change and a voltage value at the inflection point; and calculating the degree of degradation of the secondary battery based on a voltage value at the inflection point and charge/discharge history data of the secondary battery.

The present disclosure contains subject matter related to that disclosed in Japanese Priority Patent Application JP 2012-120454 filed in the Japan Patent Office on May 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

1. A charge control device for a secondary battery that controls a charge of the secondary battery including positive and negative electrodes, the device comprising:
a degradation degree detection and evaluation unit that detects and evaluates a degree of degradation of the secondary battery; and
a charge control unit,
wherein the charge control unit controls a voltage application state to the electrode at a time of charge of the secondary battery based on an evaluation result of the degree of degradation of the second battery in the degradation degree detection and evaluation unit.

2. The charge control device for a secondary battery according to claim 1, wherein the charge control unit controls a voltage application state to the positive electrode at a time of full charge of the secondary battery based on the evaluation result of the degree of degradation of the second battery in the degradation degree detection and evaluation unit.

3. The charge control device for a secondary battery according to claim 2, wherein the charge control unit sets a potential of the positive electrode at the time of full charge of the secondary battery based on the evaluation result of the degree of degradation of the second battery in the degradation degree detection and evaluation unit.

4. The charge control device for a secondary battery according to claim 3,
wherein the degradation degree detection and evaluation unit measures a voltage change between the positive and negative electrodes at a time of charge or discharge of the secondary battery, calculates an inflection point in the measured voltage change, and calculates the degree of degradation of the secondary battery based on a difference between the inflection point and a precalculated initial inflection point, and
wherein the charge control unit sets a potential of the positive electrode to be applied at the time of charge of the secondary battery based on the degree of degradation of the second battery calculated by the degradation degree detection and evaluation unit.

5. The charge control device for a secondary battery according to claim 4, wherein the difference is based on a relation between the inflection point in the measured voltage change and the precalculated initial inflection point.

6. The charge control device for a secondary battery according to claim 4, wherein the inflection point in the measured voltage change corresponds to a peak in differential values when the differential values of a voltage measured by setting a charge/discharge capacity of the secondary battery or a measurement time as a variable are calculated.

7. The charge control device for a secondary battery according to claim 1, wherein the charge control unit controls a voltage to be applied to the positive electrode at the time of charge of the secondary battery based on the evaluation result of the degree of degradation of the second battery in the degradation degree detection and evaluation unit.

8. The charge control device for a secondary battery according to claim 1, wherein the negative electrode is formed of a material in which an inflection point is present in a potential change at the time of charge or discharge of the secondary battery and the positive electrode is formed of a material in which no inflection point is present in the potential change.

9. The charge control device for a secondary battery according to claim 8,
wherein the secondary battery includes a lithium-ion secondary battery,
wherein the negative electrode is formed of graphite, and
wherein the positive electrode is formed of lithium iron phosphate.

10. A secondary battery device comprising:
a secondary battery that includes positive and negative electrodes; and
a charge control device that controls a charge of the secondary battery,
wherein the charge control device includes
a degradation degree detection and evaluation unit that detects and evaluates a degree of degradation of the secondary battery, and
a charge control unit, and
wherein the charge control unit controls a voltage application state to the electrode at a time of charge of the secondary battery based on an evaluation result of the degree of degradation of the second battery in the degradation degree detection and evaluation unit.

11-33. (canceled)
